(19) United States
(12) Patent Application Publication
(10) Pub. No.: US 2023/0196492 A1
(43) Pub. Date: Jun. 22, 2023

(54) GENERATING NETWORK COVERAGE IMPROVEMENT METRICS UTILIZING MACHINE-LEARNING TO DYNAMICALLY MATCH TRANSPORTATION REQUESTS

(71) Applicant: Lyft, Inc., San Francisco, CA (US)

(72) Inventors: Arthur Jean Francois Braud, San Francisco, CA (US); Janie Jia Gu, San Francisco, CA (US); Titouan Alexandre Kevin Jehl, Berkeley, CA (US); Guy-Baptiste Richard de Capele d'Hautpoul, San Francisco, CA (US); Di Wu, San Francisco, CA (US)

(21) Appl. No.: 17/556,024

(22) Filed: Dec. 20, 2021

(51) Int. Cl. G06Q 50/30; G06N 7/00; G06Q 10/06

(52) U.S. Cl. CPC G06Q 50/30; G06N 7/005; G06Q 10/06315

(57) ABSTRACT

Methods, systems, and non-transitory computer readable storage media are disclosed for generating transportation matches for transportation requests utilizing one or more efficiency metrics based on network coverage in a region. For example, the systems utilize regional and sub-regional network coverage features to generate a predicted network coverage improvement metric resulting from not assigning a particular provider device to a transportation request according to the regional network coverage features. Additionally, the systems utilize regional network coverage features to determine possible request states for a transportation request. The systems then utilize a Markov decision model policy based on the request states to generate an unmatched requester device efficiency metric associated with leaving the request unassigned for a time period. The systems also utilize the network coverage improvement metric and/or the unmatched requester device efficiency metric to generate a transportation match for the transportation request.

### BACKGROUND

In recent years, transportation matching systems have introduced significant technological improvements in mobile app-based matching of transportation providers and requesters. Indeed, the proliferation of web and mobile applications enable requesting computer devices to submit transportation requests via on-demand transportation matching systems. On-demand transportation matching systems can identify available provider computing devices that can provide transportation services from one geographic location to another and efficiently identify digital matches between provider computing devices and requester computing devices. Although conventional transportation matching systems can match requesting computing devices with provider computing devices, conventional systems often face a number of technical problems, particularly with respect to flexibility of operation and efficiency of implementing computing devices.

### SUMMARY

One or more embodiments provide benefits and/or solve one or more of the foregoing or other problems in the art with systems, methods, and non-transitory computer readable storage media that generate transportation matches for transportation requests utilizing machine-learning generated network coverage efficiency metrics (e.g., metrics reflecting lost driver device opportunity or open demand). In particular, the disclosed systems can improve overall efficiency by accounting for system improvements that result from not assigning a provider device and leaving a transportation request open for matching at a later time. Indeed, the disclosed systems can reduce wasted system resources and inefficient network coverage that results from dispatching provider devices to transportation requests that are less efficient relative to leaving a provider device unassigned at a particular location. Similarly, the disclosed systems can reduce inefficiencies that result from assigning a transportation request when a more efficient transportation match is likely to result at a future moment within the time remaining to assign the transportation request. In this manner, the disclosed systems can improve throughput, network coverage, and computational resources of a transportation matching system.

In particular, based on receiving a transportation request, the disclosed systems determine regional network coverage features corresponding to requester devices and provider devices within the corresponding region. The disclosed systems utilize a machine-learning model to generate a predicted network coverage improvement metric resulting from not assigning a particular provider device to the transportation request according to the regional network coverage features. For example, the disclosed systems generate the predicted network coverage improvement metric based on a provider device utilization score generated for the region utilizing the machine-learning model and a response time score generated for a geohash within the region utilizing a device utilization model. The disclosed systems then utilize a transportation matching model to generate a transportation match for the transportation request based on the predicted network coverage improvement metric.

In one or more additional embodiments, the disclosed systems generate transportation matches for transportation requests utilizing unmatched requester device efficiency (e.g., a measure of open demand value resulting from not matching the requester device) generated via a Markov decision process. Specifically, in response to a transportation request, the disclosed systems determine a plurality of state features corresponding to possible request states of the transportation request. The disclosed systems determine a transition matrix indicating probabilities of transitioning between request states based on characteristics of a region or sub-region associated with the request. The disclosed systems then determine a Markov decision model policy for the request based on the transition matrix. After determining the Markov decision model policy, the disclosed systems generate an unmatched requester device efficiency metric for the request state utilizing the Markov decision model policy for a current time window and one or more future time windows corresponding to a remaining time of the transportation request. The disclosed systems can thus flexibly and efficiently identify provider devices to respond to transportation requests while improving network coverage across a region.

### BRIEF DESCRIPTION OF THE DRAWINGS

The detailed description refers to the drawings briefly described below.

FIG. 1 illustrates a block diagram of an environment for implementing a network coverage efficiency system in accordance with one or more embodiments.

FIG. 2 illustrates a schematic diagram of an overview of the network coverage efficiency system utilizing a network coverage efficiency metric to generate a transportation match for a transportation request in accordance with one or more embodiments.

FIG. 3 illustrates a schematic diagram of the network coverage efficiency system generating a network coverage improvement metric from a provider device utilization score and a response time score in accordance with one or more embodiments.

FIG. 4A illustrates a map diagram including a plurality of transportation requests in connection with a transportation provider device in accordance with one or more embodiments.

FIG. 4B illustrates a diagram comparing a movement/transport time associated with a plurality of transportation requests in accordance with one or more embodiments.

FIG. 5 illustrates a map diagram of network coverage of a transportation matching system for a geographical area in accordance with one or more embodiments.

FIG. 6 illustrates a schematic diagram of an overview of the network coverage efficiency system utilizing a Markov decision model policy to generate a transportation match for a transportation request in accordance with one or more embodiments.

FIG. 7 illustrates a schematic diagram of the network coverage efficiency system determining a Markov decision model policy from a transition matrix for a plurality of request states corresponding to a transportation request in accordance with one or more embodiments.

FIG. 8A illustrates a decision tree for determining a plurality of request states for a transportation request in accordance with one or more embodiments.

FIG. 8B illustrates a transition matrix corresponding to a plurality of request states for a transportation request in accordance with one or more embodiments.

FIG. 9 illustrates a map diagram of network coverage of a transportation matching system for a region in accordance with one or more embodiments.

FIG. 10 illustrates a diagram of the network coverage efficiency system generating a transportation match based on a network coverage improvement metric and an unmatched requester device efficiency metric in accordance with one or more embodiments.

FIG. 11 illustrates a graphical user interface of a transportation provider device presenting a transportation request in accordance with one or more embodiments.

FIG. 12 illustrates a flowchart of a series of acts for utilizing a machine-learning model to generate a network coverage improvement metric for matching a transportation request to a transportation provider device in accordance with one or more embodiments.

FIG. 13 illustrates a flowchart of a series of acts for utilizing a Markov decision model policy based on a plurality of request states for matching a transportation request to a transportation provider device in accordance with one or more embodiments.

FIG. 14 illustrates a block diagram of a computing device in accordance with one or more embodiments.

FIG. 15 illustrates an example environment for a transportation matching system in accordance with one or more embodiments.

### DETAILED DESCRIPTION

This disclosure describes one or more embodiments of a network coverage efficiency system that generates efficiency metrics for improving network coverage within a region while matching transportation requests to transportation provider devices. In particular, based on receiving a transportation request in a region, the network coverage efficiency system utilizes data associated with the region to generate one or more metrics related to coverage efficiency and/or device efficiency. For example, when an availability of provider devices in the region is insufficient for matching to current transportation requests, the network coverage efficiency system generates one or more metrics for determining whether to assign a particular provider to a particular request based on the coverage efficiency and/or device efficiency metrics. To illustrate, the network coverage efficiency system can generate a network coverage improvement metric (e.g., that reflects an expected improvement resulting from leaving a driver unassigned) and an unmatched requester device efficiency metric (e.g., that reflects improvements of leaving a transportation request unmatched). By analyzing efficiency and network coverage improvements resulting from not assigning a provider device or delaying a transportation match for a transportation request, the disclosed systems can more efficiently utilize available provider devices, increase network coverage (e.g., improve throughput), and reduce computational resources.

In one or more embodiments, the network coverage efficiency system receives a transportation request from a transportation device. For instance, the network coverage efficiency system is part of a transportation matching system that matches transportation requests from transportation requester devices to transportation provider devices in a region. In one or more embodiments, in connection with generating transportation matches for requests, the network coverage efficiency system determines regional network coverage features for the region. To illustrate, the network coverage efficiency system determines information about provider device locations, request locations, destination locations, and other regional or sub-regional data in a region or sub-region.

According to one or more embodiments, the network coverage efficiency system generates a predicted network coverage improvement metric resulting from not assigning a particular provider device to the request (e.g., a value of lost driver device opportunity). Indeed, the network coverage efficiency system can analyze a variety of features to determine a forecasted improvement resulting from not assigning a provider device. For example, the network coverage efficiency system can take into account available or forecasted transportation requests, available or forecasted provider devices, destinations, estimated times, ride lengths, and other factors. In one or more embodiments, the network coverage efficiency system utilizes a machine learning model to determine the predicted network coverage improvement metric.

For example, the network coverage efficiency system can utilize a machine-learning model to generate a predicted measure of incremental fulfilled transportation requests per additional provider device availability metric for the region. The network coverage efficiency system then generates a provider device utilization score based on the predicted measure output of the machine-learning model. In one or more embodiments, the network coverage efficiency system utilizes a device utilization model to generate a threshold response time for a sub-region (e.g., a geohash) within the region based on sub-regional network coverage features. The network coverage efficiency system then generates a response time score for the transportation request relative to a provider device based on the threshold response time. The network coverage efficiency system can then generate the network coverage improvement metric based on the provider device utilization score and the response time score.

In one or more embodiments, the network coverage efficiency system generates a transportation match from the network coverage improvement metric. For example, the network coverage efficiency system utilizes (or otherwise communicates with) a transportation matching model to select a provider device to match to the transportation request. To illustrate, the network coverage efficiency system utilizes the transportation matching model to determine whether to assign a particular provider device to the request based on a predicted request metric associated with the request and a network coverage improvement metric in connection with a particular provider device.

As mentioned above, in some embodiments, the network coverage efficiency system determines an unmatched requester device efficiency metric (e.g., a metric reflecting open demand from not matching a requestor device). In particular, the network coverage efficiency system can determine an unmatched requester device efficiency metric by exploring the possible paths of leaving a transportation request unassigned. In some implementations, the network coverage efficiency system determines an unmatched requester device efficiency metric at a particular frequency (e.g., every 2 seconds or every 2 minutes) to determine whether to assign a transportation request to a particular driver. In some implementations the network coverage efficiency system utilizes a Markov decision process (e.g., a Markov decision stopping model) to determine the unmatched requester device efficiency metric.

For example, in response to a transportation request in a region, the network coverage efficiency system determines a plurality of possible states for the transportation request in a Markov decision model. Specifically, the network coverage efficiency system determines state features based on complex contextual information associated with the transportation request and provider devices in the region (e.g., current provider device distances, conversion rate, driver device rate). The network coverage efficiency system then determines the possible request states for the transportation request based on the state features.

In one or more embodiments, the network coverage efficiency system determines a Markov decision model policy corresponding to the possible request states. For instance, the network coverage efficiency system analyzes historical transportation request information to generate a transition matrix representing probabilities of transitioning between the possible request states based on characteristics of the region and/or sub-region associated with the transportation request. The network coverage efficiency system then determines the Markov decision model policy based on the transition matrix associated with the possible request states.

In some embodiments, the network coverage efficiency system generates an unmatched requester device efficiency metric for the transportation request utilizing the Markov decision model policy. In particular, the network coverage efficiency system determines the unmatched requester device efficiency metric indicating whether to match a particular provider to a request within a given time window. For example, the network coverage efficiency system utilizes the Markov decision model policy to determine the unmatched requester device efficiency metric for a particular request given an amount of remaining time and a request state for the request.

According to one or more embodiments, the network coverage efficiency system generates a transportation match from the unmatched requester device efficiency metric. For instance, the network coverage efficiency system communicates with a transportation matching model to select a provider device to match to the transportation request. To illustrate, the network coverage efficiency system utilizes the transportation matching model to determine whether to assign a particular provider device to the request at a given time based on a predicted request metric associated with the request and an unmatched requester device efficiency metric associated with the transportation request. In some embodiments, the network coverage efficiency system utilizes both a network coverage improvement metric and an unmatched requester device efficiency metric associated with a transportation request to match a provider device to the request.

As mentioned, although conventional transportation matching systems can match requesting computing devices with provider computing devices, conventional systems often face a number of technical problems, particularly with respect to flexibility of operation and efficiency of implementing computing devices. In particular, conventional transportation matching systems frequently utilize fixed or inflexible methods for matching provider vehicles with requesters. For instance, many conventional systems rigidly rely on computer implemented algorithms for immediately matching available provider vehicles and requesters. Focusing rigidly on immediately matching provider vehicles with requesters often undermines system functionality to adjust to device imbalances. For example, conventional systems cannot flexibly respond to significant shortages in driver devices and/or requestor devices.

Additionally, conventional transportation matching systems often operate inefficiently in matching provider devices and requester devices. In particular, conventional systems often inefficiently utilize time, communication, and computing resources when matching provider vehicles with requesters. These inefficiencies are exacerbated by poor network coverage resulting from device imbalances, such as a shortfall in provider devices relative to the number of requestor devices. For instance, many conventional transportation matching systems generate inefficient matches that require significant time for provider devices to travel to requester devices and significant time for servers, provider devices, and requester devices to operate in managing a transportation match. This additional waiting time translates to additional and excessive network bandwidth and utilization of computational resources. Indeed, each additional minute of inefficient time translates to multiple different queries from requester devices (e.g., updates regarding provider device locations, duplicate digital transportation requests, queries regarding other transportation options, etc.), and provider devices (e.g., navigational queries, queries regarding alternative pick-up options, etc.).

Moreover, excessive travel/waiting time often results in additional digital cancellations, which leads to duplicate network traffic and computational processing (e.g., additional requests from requester devices, communication with provider devices, and server resources in identifying duplicate matches and coordinating transportation services). To illustrate, due at least in part to the inflexibility of the conventional systems, the conventional systems are also unable to efficiently handle imbalances in network coverage for a given area. For example, by utilizing a rigid matching process that matches transportation requester devices to provider devices immediately when provider devices become available, the conventional systems do not efficiently handle periods when the number of pending transportation requests is greater than the number of available provider devices. These imbalances result in matches with long wait times that inefficiently dispatch provider devices, which further results in letting other transportation requests lapse due to long wait times without matching the requests.

The network coverage efficiency system provides several technical benefits relative to conventional systems. For example, the network coverage efficiency system can improve flexibility of operation relative to conventional systems. In particular, the network coverage efficiency system flexibly utilizes various approaches for selecting a provider device to fulfill a transportation request. In contrast to conventional systems that rigidly focus on immediately identifying transportation matches from available provider devices, the network coverage efficiency system generates one or more efficiency metrics related to network coverage to determine whether to assign a provider device to a request at any given time, thereby delaying the selection of a provider device. More specifically, instead of immediately selecting a provider device at the time of the transportation request, as with conventional systems, the network coverage efficiency system can consider the value of not assigning a provider device and/or leaving a requestor device unmatched. Indeed, the network coverage efficiency system can analyze network coverage efficiency metrics (reflecting driver device opportunity) and/or unmatched requester device efficiency metrics (reflecting open requestor device value) to more flexibly generate transportation matches between requestor devices and provider devices. For instance, the network coverage efficiency system can flexibly select a provider device within a time period after the transportation request based on network coverage in a region. This also allows a transportation matching system to more flexibly manage the network coverage of provider devices within and across regions to more completely match requests when provider devices and requests are imbalanced.

Additionally, the network coverage efficiency system can improve efficiency of computing systems that implement matching of transportation requests to provider devices. In particular, as mentioned, the network coverage efficiency system can more efficiently utilize computing, time, and communication resources in connection with network coverage of a transportation matching system. More specifically, the network coverage efficiency system can reduce computing inefficiencies resulting from unnecessary travel time, unexpected wait times, and request submissions and processing. Indeed, by generating efficiency metrics representing device utilization and network coverage in connection with provider devices in a given region or sub-region, the network coverage efficiency system can match and dispatch provider devices to transportation requests with improved efficiency, which can significantly reduce unnecessary communications bandwidth, queries, and processing resources. Furthermore, by more efficiently matching transportation requests, the network coverage efficiency system can significantly reduce the number of digital rejections/cancellations from requester devices and provider devices, which further reduces the numbers of queries, status update requests, and other digital communication that strain network bandwidth and processing resources. In addition, by reducing cancellations, the network coverage efficiency system can further improve utilization of computational resources required to determine transportation matches by avoiding duplicate and unnecessary computer matching processes.

The network coverage efficiency system can also improve accuracy relative to conventional systems. As mentioned above, the network coverage efficiency system can utilize real-time signals in conjunction with a machine learning model to determine a network coverage improvement metric that accurately reflects the value of leaving a provider device unassigned. Similarly, the network coverage efficiency system can utilize a Markov decision model that incorporates a variety of contextual signals to more accurately determine unmatched requester device efficiency metrics that reflect the value of leaving a requester device unassigned. The improved accuracy of these approaches relative to conventional systems drives the efficiency and flexibility improvements discussed above.

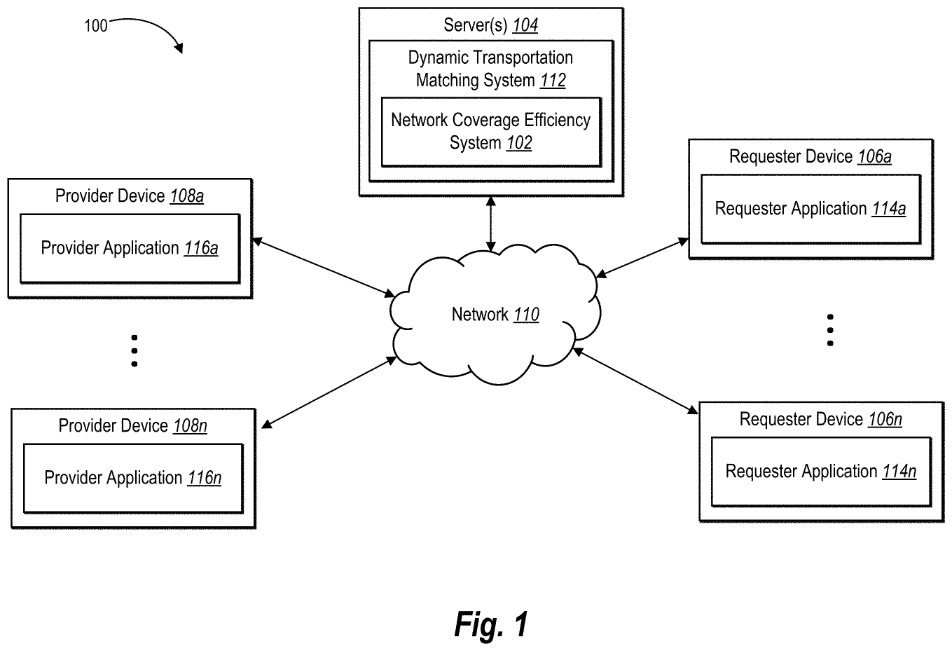

Turning now to the figures, FIG. 1 illustrates a schematic diagram of a system environment 100 in which a network coverage efficiency system 102 is implemented. In particular, the system environment 100 includes server(s) 104, requester devices 106a-106n, and provider devices 108a-108n in communication via a network 110. Moreover, as shown, the server(s) 104 include a dynamic transportation matching system 112, which includes the network coverage efficiency system 102. As further illustrated in FIG. 1, the requester devices 106a-106n include requester applications 114a-114n, and the provider devices 108a-108n include provider applications 116a-116n.

As shown in FIG. 1, in one or more implementations, the server(s) 104 include or hosts the dynamic transportation matching system 112. Specifically, the dynamic transportation matching system 112 includes, or is part of, one or more systems that implement matching transportation requests for providing transportation services. For example, the dynamic transportation matching system 112 communicates with the requester devices 106a-106n to receive transportation requests for providing transportation services to requesters (e.g., users) associated with the requester devices 106a-106n. For example, the requesters utilize the requester applications 114a-114n of the requester devices 106a-106n to provide the transportation requests to the dynamic transportation matching system 112 via the network 110. In some embodiments, the server(s) 104 send data to and receive data from the requester devices 106a-106n associated with transportation services and for displaying information associated with the services via the requester applications 114a-114n.

In addition to communicating with requester devices 106a-106n, the dynamic transportation matching system 112 also communicates with the provider devices 108a-108n in connection with transportation requests. Specifically, the dynamic transportation matching system 112 generates transportation matches for transportation requests by assigning specific provider devices to the transportation requests based on a variety of match criteria. To illustrate, the dynamic transportation matching system 112 utilizes location data, availability (e.g., whether a provider device is available for transportation requests), and other data associated with provider devices and/or of a region in which the transportation requests are located to assign provider devices to transportation requests. The dynamic transportation matching system 112 then communicates with the provider devices 108a-108n to send data associated with the transportation matches to the provider devices 108a-108n (e.g., for display within the provider applications 116a-116n). In one or more embodiments, the dynamic transportation matching system 112 also provides information associated with transportation requests (e.g., pick-up location, destination location, requester information, transportation value, estimated duration, estimated time of arrival).

Furthermore, as illustrated in FIG. 1, the dynamic transportation matching system 112 includes the network coverage efficiency system 102. In one or more embodiments, the dynamic transportation matching system 112 utilizes the network coverage efficiency system 102 to generate one or more metrics associated with network coverage and provider device utilization within a plurality of regions. For example, the network coverage efficiency system 102 generates a predicted network coverage improvement metric or an unmatched requester device efficiency metric for a transportation request and/or for a provider device within a region of a transportation request. The dynamic transportation matching system 112 can then utilize the predicted network coverage improvement metric and/or the unmatched requester device efficiency metric to generate transportation matches for one of the provider devices 108a-108n.

As illustrated in FIG. 1, the system environment 100 includes the requester devices 106a-106n and the provider devices 108a-108n. As used herein, the term “requester device” or “transportation requester device” refers to a computing device associated with (or used by) a requester. In some embodiments, a requester device includes a requester application comprising instructions that (upon execution) cause the requester device to perform various actions for a dynamic transportation matching system. In one or more embodiments, a requester application includes a web browser, applet, or other software application (e.g., native application) available to the requester device.

Additionally, as used herein, the term “provider device” or “transportation provider device” refers to a computing device associated (or used by) a provider or a transportation vehicle. In some embodiments, a provider device includes a provider application comprising instructions that (upon execution) cause the provider device to perform various actions for a transportation matching system. A provider device can include a mobile computing device (e.g., a smartphone) or a computing device installed (or otherwise integrated) into a transportation vehicle for displaying information associated with a provider user and/or transportation requests. Such instructions may likewise cause a provider device to present a graphical user interface identifying one or more premium metrics for one or more target geocoded areas (e.g., within a heatmap).

As used herein, the term “transportation request” refers to a request from a requesting device (i.e., a requester device) for transport by a transportation vehicle. In particular, a transportation request includes a request for a transportation vehicle to transport a requester or a group of individuals from one geographic area to another geographic area. A transportation request can include information such as a pick-up location, a destination location (e.g., a location to which the requester wishes to travel), a request location (e.g., a location from which the transportation request is initiated), location profile information, a requester rating, or a travel history. As an example of such information, a transportation request may include an address as a destination location and the requester's current location as the pick-up location. A transportation request can also include a requester device initiating a session via a transportation matching application and transmitting a current location (thus, indicating a desire to receive transportation services from the current location).

Although not illustrated in FIG. 1, in some embodiments, the system environment 100 may have a different arrangement of components and/or may have a different number or set of components altogether. In certain implementations, for instance, some or all of the transportation vehicles (associated with corresponding provider devices) do not include a human provider, but constitute autonomous transportation vehicles—that is, a self-driving vehicle that includes computer components and accompanying sensors for driving without manual-provider input from a human operator. As a further example, in some embodiments, one or more of the transportation vehicles include a hybrid self-driving vehicle with both self-driving functionality and some human operator interaction.

When a transportation vehicle is an autonomous vehicle or a hybrid self-driving vehicle, the transportation vehicle may include additional components not depicted in FIG. 1. Such components may include location components, one or more sensors by which the autonomous vehicle navigates, and/or other components necessary to navigate without a provider (or with minimal interactions with a provider). Regardless of whether a transportation vehicle is associated with a provider, a transportation vehicle optionally includes a locator device, such as a GPS device, that determines the location of the transportation vehicle within the transportation vehicles.

As mentioned above, the provider devices 108a-108n may be separate or integral to transportation vehicles. Additionally, or alternatively, a provider device may be a subcomponent of a vehicle computing system. Regardless of its form, the provider devices 108a-108n may include various sensors, such as a GPS locator, an inertial measurement unit, an accelerometer, a gyroscope, a magnetometer, and/or other sensors, from which the dynamic transportation matching system 112 can access information, such as location information.

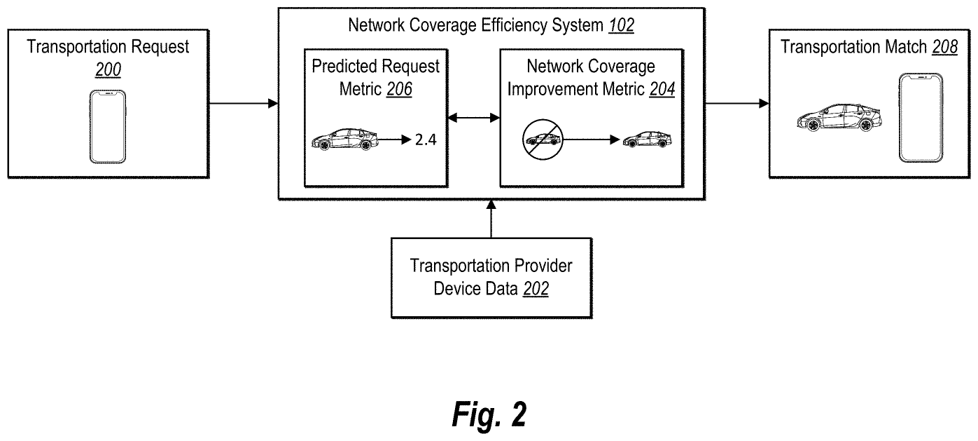

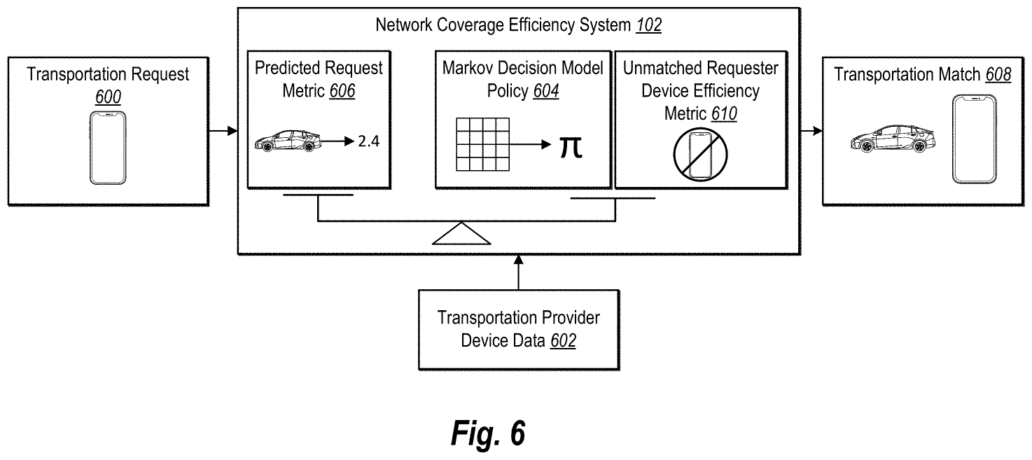

As previously mentioned, the network coverage efficiency system 102 can generate a variety of metrics associated with network coverage for generating transportation matches via a transportation matching system. Specifically, the network coverage efficiency system 102 can generate a network coverage improvement metric that reflects the value of not assigning a driver to a transportation request and the network coverage efficiency system 102 (e.g., a driver opportunity cost) and can also generate an unmatched requester device efficiency metric that reflects the value of not assigning a transportation request (e.g., an open demand value). FIGS. 2-5 will provide additional detail regarding the network coverage improvement metric and FIGS. 6-9 will provide additional detail regarding the unmatched requester device efficiency metric.

For example, FIG. 2 illustrates a diagram of an overview of a process in which the network coverage efficiency system 102 generates a network coverage improvement metric (reflecting the value of not assigning a provider device) in connection with a transportation request and a particular provider device. Specifically, FIG. 2 illustrates utilizing the network coverage improvement metric to match a transportation request to a provider device.

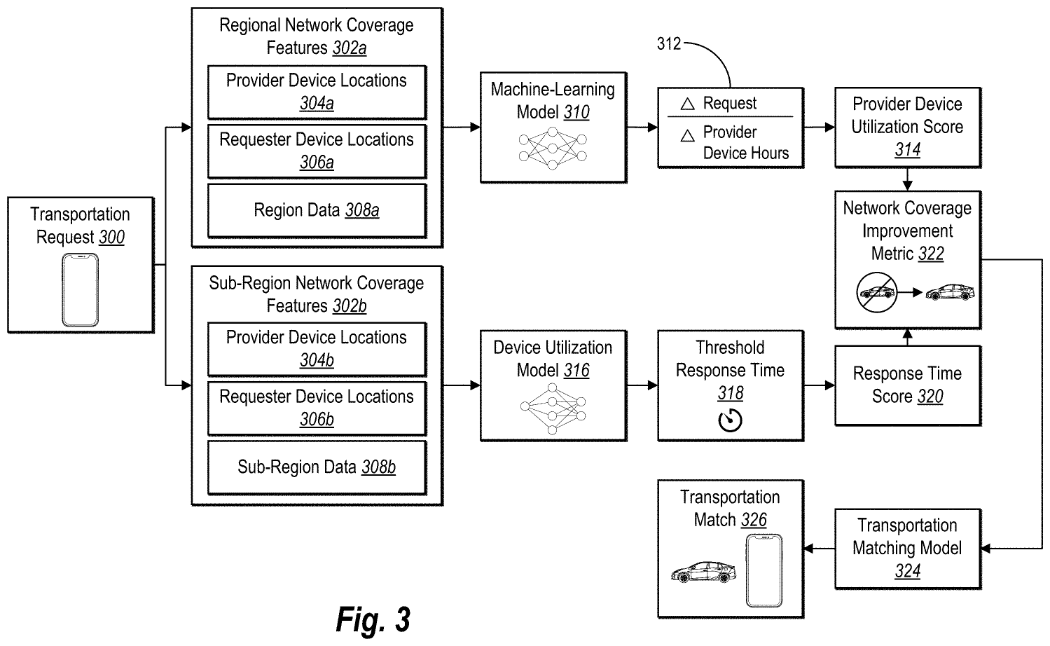

In one or more embodiments, as illustrated in FIG. 2, the network coverage efficiency system 102 receives a transportation request 200 to provide transportation services for a requester associated with a requester device. In connection with receiving the transportation request 200, FIG. 2 illustrates that the network coverage efficiency system 102 utilizes transportation provider device data 202 to generate a network coverage improvement metric 204 associated with the transportation request and a particular provider device. For instance, as described in more detail below with respect to FIG. 3, the network coverage efficiency system 102 generates the network coverage improvement metric 204 as a value or measure resulting from not assigning a provider device to the transportation request at least in part due to the transportation provider device data 202.

Furthermore, as illustrated in FIG. 2, the network coverage efficiency system 102 generates a predicted request metric 206 associated with the transportation request 200. Specifically, the predicted request metric 206 can include a transportation value (e.g., a predicted cost or a predicted transportation distance/time) based on the transportation request 200. In one or more embodiments, as described in more detail with respect to FIG. 3, the network coverage efficiency system 102 compares the predicted request metric 206 to the network coverage improvement metric 204 (or otherwise analyzes the network coverage improvement metric 204 in connection with the predicted request metric 206) to generate a transportation match 208. In alternative embodiments, the network coverage efficiency system 102 generates the transportation match 208 utilizing the network coverage improvement metric 204 for a provider device (or a plurality of network coverage improvement metrics for a plurality of provider devices) and without the predicted request metric 206.

FIG. 3 illustrates a detailed diagram of a process in which the network coverage efficiency system 102 generates a network coverage improvement metric in connection with a transportation request and a particular provider device. In particular, FIG. 3 illustrates that the network coverage efficiency system 102 generates the network coverage improvement metric based on a plurality of scores representing network coverage (e.g., provider device response times) and provider device utilization within a region and one or more sub-regions associated with the transportation request. FIG. 3 further illustrates that the network coverage efficiency system 102 generates a transportation match from the network coverage improvement metric based on the plurality of scores.

As illustrated in FIG. 3, in one or more embodiments, the network coverage efficiency system 102 receives a transportation request 300 from a requester device. In particular, the transportation request 300 is located within a particular region. As used herein, the term “region” refers to a spatial division or unit of a larger geographic space. For instance, in some embodiments, a region refers to a city, a collection of cities, or a portion of a city. Such regions may include, for example, Chinatown of San Francisco, Calif.; San Francisco, Calif.; or one or more of the Boroughs of New York City, N.Y. As described below, a region includes a collection of sub-regions and/or geocoded areas (i.e., “geohashes”). Additionally, as used herein, the term “geocoded area” or “geohash” refers to a spatial subdivision or subunit of a sub-region or a larger geographic space. A geocoded area may be a subdivision of a geographic neighborhood as well as a subdivision of a city. As a subdivision, a geocoded area may include a segment of a street, a street, a set of bordering streets, a city block, a set of city blocks, or another portion of an area within a larger geographic space. For example, a set of bordering streets may define a geocoded area within a larger space, such as a set of streets around Times Square in New York City, N.Y. In certain embodiments, a geocoded area represents a geographic hash in a grid (or other polygon shape) of geohashes within a larger geographic space. Regardless of the form of a geocoded area, one or more requesters and corresponding requester devices or providers and corresponding provider devices may be located within a geocoded area.

After receiving the transportation request 300, the network coverage efficiency system 102 determines data associated with the transportation request 300. For example, as illustrated in FIG. 3, the network coverage efficiency system 102 determines regional network coverage features 302a for the region in which the transportation request 300 is located. As used herein, the term “regional network coverage features” refer to data indicating characteristics of a region in connection with transportation services within the region. For example, as illustrated, the regional network coverage features 302a include provider device locations 304a, requester device locations 306a, and region data 308a. In one or more embodiments, the regional network coverage features 302a include historical data associated with the region. The regional network coverage features provide signals to the network coverage efficiency system 102 related to network coverage of provider devices relative to transportation requests for the region.

In one or more embodiments, the provider device locations 304a include location data associated with provider devices within or near the region of the transportation request. For example, the network coverage efficiency system 102 can communicate with a plurality of provider devices associated with a transportation matching system. To illustrate, as mentioned above with respect to FIG. 1, provider devices are associated with transportation vehicles. According to one or more embodiments, each provider device includes a position tracking device (e.g., a GPS sensor) that indicates to the network coverage efficiency system 102 where the provider device is located. The network coverage efficiency system 102 can thus determine the positions of any provider devices within the region of the transportation request 300.

In addition to determining the provider device locations 304a, the network coverage efficiency system 102 also determines the requester device locations 306a for a plurality of requester devices in or near the region. Specifically, the network coverage efficiency system 102 determines requester devices associated with transportation requests in the region. For instance, the network coverage efficiency system 102 can track the location data of requester devices from past transportation requests within the region (including recently completed transportation requests). In some embodiments, the network coverage efficiency system 102 also tracks the location of requester devices for ongoing or pending (e.g., unmatched) transportation requests. The provider device locations 304a and the requester device locations 306a can also be utilized to determine additional features, such as distances between requester devices and provider devices, estimated travel (or arrival) times for provider devices to various requester devices, and/or distances between provider devices (e.g., relative clusters of provider devices or requestor devices).

Furthermore, as illustrated in FIG. 3, the regional network coverage features 302a include region data 308a. In one or more embodiments, the region data 308a includes a region identifier associated with the region. Additionally, the region data 308a can include specific details associated with the region that may affect the number of transportation requests at a given time such as, but not limited to, population, events, demographics of people in the region, entities within the region (e.g., businesses or frequently traveled locations), traffic data, tourism data, device balance information (e.g., relative numbers of requester devices and provider devices), and previous transportation requests (e.g., completed requests, canceled requests). The region data 308a can also include data based on, or otherwise associated with, the provider device locations 304a or the requester device locations 306a, such as historical averages, seasonal data, etc.

FIG. 3 illustrates that the network coverage efficiency system 102 utilizes the regional network coverage features 302a as input to a machine-learning model 310. As used herein, the term “machine-learning model” refers to a computer representation that is tuned (e.g., trained) based on inputs to approximate unknown functions. To illustrate, a machine learning model can include a decision tree model (e.g., a random forest model or XGBoost), a neural network, or a support vector machine. For instance, a machine-learning model can include a neural network that has one or more layers or artificial neurons that approximate unknown functions by analyzing known data at different levels of abstraction. In some embodiments, a machine-learning model includes one or more neural network layers including, but not limited to, a deep learning model, a convolutional neural network, a recurrent neural network, a feed forward neural network, a generative neural network, an adversarial neural network, or a combination of a plurality of neural network types.

In one or more embodiments, the machine-learning model 310 includes, but is not limited to, one or more neural network layers to generate predicted one or more metrics associated with transportation requests. For instance, as illustrated in FIG. 3, the machine-learning model 310 utilizes the regional network coverage features 302a to generate a predicted measure 312 of incremental fulfilled transportation requests per additional transportation provider device availability metric. To illustrate, the predicted measure 312 of incremental fulfilled transportation requests per additional transportation provider device availability metric can represent a number of additional transportation requests predicted to be completed per additional unit of available provider device time unit. As an example, the predicted measure 312 includes a number of transportation requests completed for every additional provider hour in the region, though the predicted measure 312 can be for any additional time unit. Alternatively, the predicted measure 312 includes a number of additional transportation requests per additional provider device available within the region.

After generating the predicted measure 312, the network coverage efficiency system 102 can generate a score based on the predicted measure 312. Specifically, as illustrated in FIG. 3, the network coverage efficiency system 102 generates a provider device utilization score 314 from the predicted measure 312. To illustrate, the network coverage efficiency system 102 can convert the predicted measure 312 to a specific score or format that can be compared to other metrics. In some embodiments, the network coverage efficiency system 102 determines a cost metric based on the predicted measure 312 by utilizing an average cost value associated with transportation requests for the region. Alternatively, the network coverage efficiency system 102 determines a different score type by modifying the predicted measure 312 utilizing a parameter associated with the particular region relative to other regions. Thus, the network coverage efficiency system 102 can generate the provider device utilization score 314 by normalizing the predicted measure 312 relative to one or more other regions.

In addition to utilizing the regional network coverage features 302a to generate the provider device utilization score 314 corresponding to the region, the network coverage efficiency system 102 can also generate a score based on sub-region-specific data. For example, FIG. 3 illustrates that the network coverage efficiency system 102 determines sub-region network coverage features 302b for a sub-region (e.g., a geohash) within the region in which the transportation request 300 is located. To illustrate, the sub-region network coverage features 302b include provider device locations 304b, requester device locations 306b, and sub-region data 308b. In one or more embodiments, the sub-region network coverage features include current or recent data associated with the particular sub-region. Because the sub-region network coverage features 302b can include current or recent data associated with the sub-region, the sub-region network coverage features 302b can have higher variability than the regional network coverage features 302a.

In one or more embodiments, the provider device locations 304b of the sub-region network coverage features 302b include location data associated with provider devices within or near the sub-region. Additionally, in one or more embodiments, the requester device locations 306b include location data associated with requester devices (e.g., associated with transportation requests) in or near the sub-region. As discussed above, these location features can also include distances between requester devices and provider devices, estimated travel (or arrival) times for provider devices to various requester devices. Furthermore, the sub-region data 308b can include a sub-region identifier (e.g., a geohash) and specific details associated with the sub-region (e.g., population, number of requester devices/provider devices, demographics, traffic data, entities, tourism data, previous transportation requests).

In one or more embodiments, the network coverage efficiency system 102 utilizes a device utilization model 316 to generate a threshold response time 318 based on the sub-region network coverage features 302b. The device utilization model 316 can include a variety of computer implemented models or algorithms to determine utilization of provider devices relative to requester devices within a transportation matching system. For example, the device utilization model 316 can include an optimization model (or objective function) that determines an optimal variable or metric (e.g., travel time or travel radius) to service transportation requests with corresponding provider devices within a particular region. To illustrate, if network coverage features 302b indicate that a new transportation request surfaces every minute, the device utilization model 316 can determine an expected radius or travel time within which to search for provider devices to satisfy the transportation requests. Similarly, the device utilization model 316 can include a trained machine learning model that generates a predicted variable or metric to service transportation requests for a particular region.

For example, in one or more embodiments, the network coverage efficiency system 102 utilizes the sub-region network coverage features 302b to predict the response time associated with transportation requests based on the sub-region network coverage features 302b. For instance, the network coverage efficiency system 102 utilizes the device utilization model 316 to predict an average response time (or distance) associated with traveling to pick-up locations of transportation requests within the sub-region. The average response time can include a mean value that thus depends on a number of provider devices within the sub-region, a number of transportation requests within the sub-region, a distance between the transportation requests in the sub-region, and/or provider devices nearby (or soon to be nearby) the sub-region. In one or more embodiments, the network coverage efficiency system 102 then determines the threshold response time 318 as the average response time or otherwise based on the average response time (e.g., average response time plus some amount of time).

According to one or more embodiments, the network coverage efficiency system 102 generates a response time score 320 based on the threshold response time 318. Specifically, the network coverage efficiency system 102 determines a response time score 320 for the transportation request 300 according to characteristics of the transportation request 300. For example, the network coverage efficiency system 102 determines a predicted response time associated with the transportation request 300 by estimating a travel distance/time between a particular provider device in the region or sub-region and a pick-up location of the transportation request 300. To illustrate, the travel distance/time can be based on traffic conditions, speed limits, etc., for a predicted route between the provider device and the pick-up location of the transportation request 300.

The network coverage efficiency system 102 can then generate the response time score 320 based on the predicted response time associated with the transportation request 300 in connection with a particular provider device. In one or more embodiments, the network coverage efficiency system 102 generates the response time score 320 by modifying the predicted response time utilizing a modifier parameter. For instance, the modifier parameter can be a fixed value parameter such as a monetary value or a normalizing value associated with the predicted response time. Alternatively, the modifier parameter can be a variable parameter that depends on the sub-region network coverage features 302b, the regional network coverage features 302a, or data associated with other regions or sub-regions.

To illustrate, if the predicted response time is 5 minutes and the threshold response time 318 is ten minutes, the network coverage efficiency system 102 can generate the response time score 320 by combining the threshold response time 318 and the predicted response time. For example, in some embodiments, the network coverage efficiency system 102 utilizes a ratio (10 minutes/5 minutes=2) between the threshold response time 318 and the predicted response time. In other embodiments, the network coverage efficiency system 102 combines the threshold response time 318 and the predicted response time utilizing a difference between the values, a conversion factor, or a multiplier.

In one or more embodiments, the network coverage efficiency system 102 utilizes the threshold response time 318 to generate the response time score 320, to modify the response time score 320, or to categorize the transportation request 300 (with the provider device) based on the response time score 320. For example, the network coverage efficiency system 102 can utilize the threshold response time 318 to generate a request filter. In particular, the network coverage efficiency system 102 can compare the response time score 320 to a threshold metric based on the threshold response time 318 (e.g., utilizing the modifier applied to the predicted response time for the transportation request 300). If the response time score 320 exceeds the threshold metric (e.g., indicating that the predicted response time is greater than the threshold response time), the network coverage efficiency system 102 can filter out the provider device for the transportation request 300.

FIG. 3 illustrates that the network coverage efficiency system 102 generates a network coverage improvement metric 322 for the transportation request 300. Because the threshold response time 318 is based on real-time data in a sub-region, the threshold response time 318 may fluctuate. Accordingly, the network coverage efficiency system 102 utilizes the response time score 320 in combination with the provider device utilization score 314 to generate the network coverage improvement metric 322. For instance, the network coverage efficiency system 102 uses the provider device utilization score 314 as a baseline to reduce noise in the signal. The network coverage efficiency system 102 can then use the response time score 320 on top of the baseline of the provider device utilization score 314.

To illustrate, the network coverage efficiency system 102 can first filter out requests with predicted response times that exceed the threshold response time 318 (or predicted response distances outside a threshold response radius). For instance, if the threshold response time 318 is 5 minutes, the network coverage efficiency system 102 can exclude transportation requests for a provider device with predicted response times greater than 5 minutes. In additional embodiments, the network coverage efficiency system 102 can utilize a filter algorithm such as: avgR/(avgP3+x) <r(o)/(P3 (o)+P2 (o)) to determine whether the transportation request 300 passes the request filter for a particular provider device. In particular, r(o) represents a value associated with the transportation request added to a value of completing a transportation request, P2 (o) represents the predicted response time (“P2 ”) for the provider device, P3 (o) represents the predicted transportation time (“P3 ”) for the provider device/transportation request 300, avgP3 represents an estimate of the average P3 of transportation requests in the sub-region, avgR represents an estimate of an average value associated with transportation requests in the sub-region added to a value of completing a transportation request, and x represents a function of real-time balance of provider devices and transportation requests in the sub-region or region.

In one or more embodiments, the network coverage efficiency system 102 determines a threshold response radius by predicting the expected wait time or idle time (“P1”) with the predicted response time as P1+P2 that a provider device experiences for any given radius. The network coverage efficiency system 102 then selects the threshold response radius to minimize the predicted P1+P2 time. The network coverage efficiency system 102 can thus utilize the threshold response radius to penalize options that leave provider devices open proportional to the predicted P1 time. In some embodiments, the network coverage efficiency system 102 utilizes the threshold response radius in addition to or as part of the threshold response time 318.

According to one or more embodiments, in response to determining that the transportation request 300 passes the request filter based on a predicted response time for the transportation request 300, the network coverage efficiency system 102 can generate the network coverage improvement metric 322. As used herein, the term “network coverage improvement metric” refers to a predicted measure (or value) resulting from not assigning a transportation provider device to a particular transportation request. In additional embodiments, a network coverage improvement metric indicates a measurement of the effect assigning a particular transportation request to a provider device on network coverage within a region or sub-region. For instance, the network coverage improvement metric can represent an opportunity cost or other metric associated with a particular transportation request according to real-time data associated with a location of the request. The network coverage efficiency system 102 thus utilizes the network coverage improvement metric to determine whether to assign each request to a particular provider device within a sub-region.

In one or more embodiments, the network coverage efficiency system 102 generates the network coverage improvement metric 322 based on the provider device utilization score 314 in combination with the response time score 320. To illustrate, the network coverage efficiency system 102 can determine a weighted average of the provider device utilization score 314 and the response time score 320. Alternatively, the network coverage efficiency system 102 utilizes the response time score 320 to filter transportation requests. The network coverage efficiency system 102 can then generate the network coverage improvement metric 322 directly from the provider device utilization score 314. For example, the network coverage efficiency system 102 can generate the network coverage improvement metric 322 as the provider device utilization score 314. In another example, the network coverage efficiency system 102 can generate the network coverage improvement metric 322 as the predicted measure 312 multiplied by an average value associated with transportation requests in the region. In some embodiments, the network coverage efficiency system 102 generates the network coverage improvement metric 322 for only the response time (e.g., the P2 time) of the transportation request 300. In additional embodiments, the network coverage efficiency system 102 generates the network coverage improvement metric 322 based on both response time (e.g., P2 time) and transportation time (e.g., P3 time) to account for the entire time a provider device is unavailable for matching to other transportation requests. Additionally, the network coverage efficiency system 102 can balance higher penalties on ride length by assigning a penalty to open provider devices (i.e., provider devices not currently assigned to transportation requests).

In one or more embodiments, the network coverage efficiency system 102 utilizes information associated with different sub-regions to generate network coverage improvement metrics for transportation requests. For instance, the network coverage efficiency system 102 can determine the network coverage improvement metric for the sub-region by determining a ratio between the average combined P2 and P3 time for transportation requests in the sub-region and the average combined P2 and P3 time for transportation requests in the region. The network coverage efficiency system 102 can then multiply the ratio by the predicted measure of incremental fulfilled transportation requests per additional transportation provider device availability metric for the region to determine the incremental fulfilled transportation requests per additional transportation provider device availability metric for the sub-region. Additionally, the network coverage efficiency system can multiply the incremental fulfilled transportation requests per additional transportation provider device availability metric of the sub-region by an average value associated with transportation requests in the sub-region to determine the network coverage improvement metric for the sub-region.

After generating the network coverage improvement metric 322 for the transportation request 300, the network coverage efficiency system 102 utilizes (or communicates with) a transportation matching model 324 to generate a transportation match 326. For example, the network coverage efficiency system 102 determines whether to match a provider device to the transportation request 300 based on the network coverage improvement metric 322 in connection with the provider device. In one or more embodiments, the network coverage efficiency system 102 utilizes the network coverage improvement metric 322 to assign the transportation request 300 to the provider device to improve network coverage in the region.

In some embodiments, the network coverage efficiency system 102 compares the network coverage improvement metric 322 of the provider device to a predicted request metric based on a transportation distance/time (e.g., P3 time) associated with the transportation request 300. To illustrate, if the predicted request metric is greater than the network coverage improvement metric 322, the network coverage efficiency system 102 can match the transportation request 300 to the provider device. Otherwise, if the network coverage improvement metric 322 is greater than the predicted request metric, the network coverage efficiency system 102 does not assign the transportation request to the provider device. In additional embodiments, the network coverage efficiency system weights the network coverage improvement metric 322 and/or the predicted request metric or combines one or both metrics with other parameters to determine whether to assign the transportation request 300 to the provider device.

In additional embodiments, the network coverage efficiency system 102 utilizes the transportation matching model 324 to generate the transportation match 326 based on additional data. For instance, the network coverage efficiency system 102 can utilize network coverage improvement metrics associated with a plurality of provider devices to select a provider device for the transportation request 300. Furthermore, the network coverage efficiency system 102 can utilize network coverage improvement metrics for other transportation requests in connection with a single provider device to select a transportation request for the provider device.

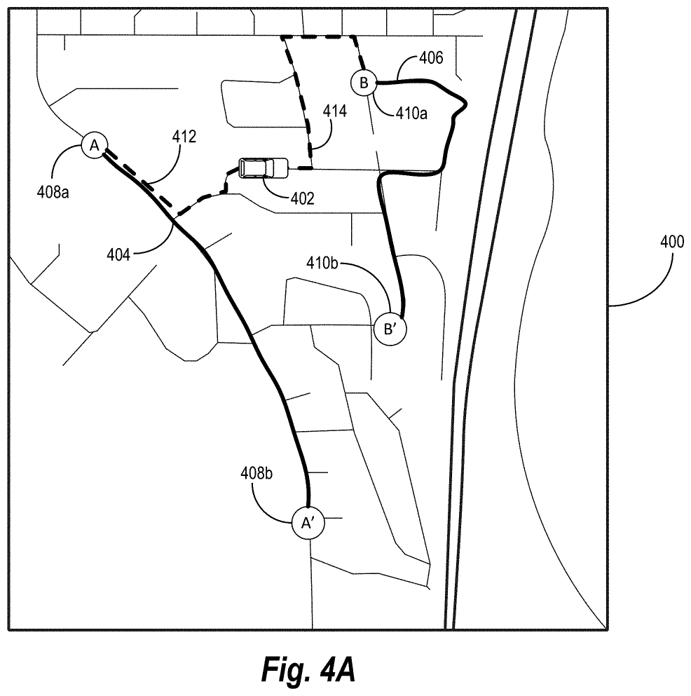

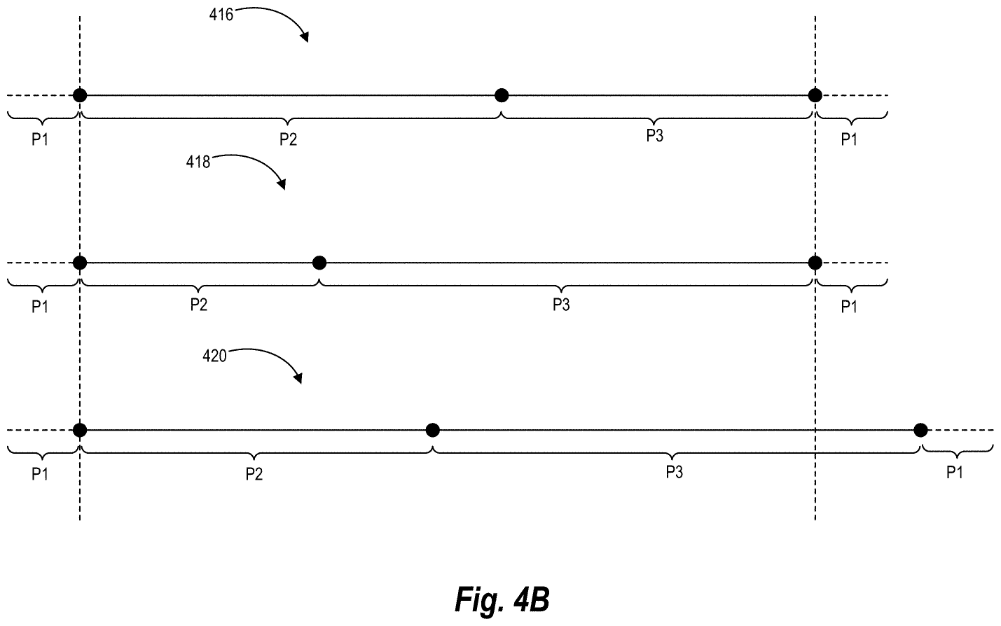

FIGS. 4A-4B illustrate examples of different transportation requests. Specifically, FIG. 4A illustrates a map diagram 400 of a region in which a plurality of transportation requests are located. For example, FIG. 4A illustrates that the map diagram 400 includes a transportation vehicle 402 at a location within the region. The transportation vehicle 402 is associated with a provider device in connection with a transportation matching system. Additionally, FIG. 4A illustrates that the map diagram 400 also includes a first transportation request 404 and a second transportation request 406 within the region.

In one or more embodiments, the region of FIG. 4A includes one or more sub-regions (e.g., geohashes). For example, the region can include a plurality of different sub-regions that the network coverage efficiency system 102 has identified and assigned sub-region identifiers. According to one or more embodiments, the first transportation request 404 and/or the second transportation request 406 can begin and/or end in the same sub-region or different sub-regions. To illustrate, the first transportation request 404 can include a pick-up location 408a in a first sub-region and a destination location 408b in a second sub-region. Additionally, the second transportation request 406 can include a pick-up location 410a in a third sub-region and a destination location 410b in a fourth sub-region. Alternatively, the pick-up location and/or the destination location of different transportation requests can be in the same sub-region.

As illustrated in FIG. 4A, the transportation vehicle 402 is a first distance 412 away from the pick-up location 408a of the first transportation request 404. In one or more embodiments, the first distance 412 corresponds to a response time associated with the first transportation request 404 for the transportation vehicle 402. Additionally, FIG. 4A illustrates that the transportation vehicle 402 is a second distance away 414 from the pick-up location 410a of the second transportation request 406. The second distance 414 corresponds to a response time associated with the second transportation request 406 for the transportation vehicle 402.

As shown, the response times of the transportation vehicle 402 for the first transportation request 404 and the second transportation request 406 can be different. Additionally, because the first transportation request 404 and the second transportation request 406 have different pick-up locations and destination locations, the corresponding transportation times between pick-up and destination can also be different. Accordingly, the network coverage efficiency system 102 generates network coverage improvement metrics for each of the transportation requests to determine which transportation request to match to the provider device associated with the transportation vehicle 402. The network coverage efficiency system 102 can then generate a transportation match for the provider device based on the network coverage improvement metrics for the first transportation request 404 and the second transportation request 406 (e.g., by comparing the predicted request metric and the network coverage improvement metrics for each request).

To illustrate, if the predicted request metric (e.g., the anticipated net income) for the first transportation request 404 is $5 and the predicted request metric for the second transportation request 406 is $7, conventional systems my assign the second transportation request 406 to the transportation vehicle 402. However, if the network coverage improvement metric for the first transportation request 404 (e.g., the opportunity cost) is $5 and the network coverage improvement metric for the second transportation request 406 is $1, the network coverage efficiency system 102 can assign the second transportation request 406 to the transportation vehicle 402. Indeed, the total value for the second transportation request 406 (i.e., $7-$5=$2) becomes less than the total value for the first transportation request 404 (i.e., $5-$132 $4).

Although the foregoing example illustrates the network coverage improvement metric as a cost (e.g., a negative value), the network coverage efficiency system 102 can express the network coverage improvement metric as a cost, a value improvement, or another metric.

FIG. 4B illustrates a comparison of movement/transport time associated with a plurality of transportation requests. Specifically, the network coverage efficiency system 102 can determine stages of a first transportation request 416, a second transportation request 418, and a third transportation request 420. As illustrated, the first transportation request 416 and the second transportation request 418 have equal total times (i.e., P2 time and P3 time), while the third transportation request 420 has a longer total time. Additionally, FIG. 4B also illustrates that wait time (P1) before and after each transportation request.

Furthermore, FIG. 4B illustrates that while the first transportation request 416 and the second transportation request 418 have the same overall time, the first transportation request 416 has a longer P2 time than the second transportation request 418. Accordingly, the first transportation request 416 has a shorter P3 time than the second transportation request 418. As further illustrated, the third transportation request has the same P3 time as the second transportation request 418. The third transportation request 420 also has a longer P2 time than the second transportation request 418 due to having a longer total time.

Because the transportation requests have different P2 and P3 times and/or total times, the network coverage efficiency system 102 generates predicted network coverage improvement metrics that represent the differences of the transportation requests. For example, each of the transportation requests can have different response time scores due to the differences in the P2 times, and in some cases due to the differences in the P3 times. In additional embodiments, the network coverage efficiency system 102 generates network coverage improvement metrics based on differences in sub-region(s) of the transportation requests. Additionally, the network coverage efficiency system 102 can then utilize the predicted network coverage improvement metrics of the different transportation requests to match a provider device to one of the transportation requests (e.g., via a transportation matching system). The network coverage efficiency system 102 can thus utilize the network coverage improvement metrics to prioritize transportation requests that provide the best network coverage for provider devices in a region.

As an example, in response to determining a particular threshold response time for one or more sub-regions associated with the transportation requests, the network coverage efficiency system 102 can select a particular transportation request. If the threshold response time is longer, for instance, the network coverage efficiency system 102 can select one transportation request (e.g., the third transportation request 420). Alternatively, if the threshold response time is shorter, the network coverage efficiency system 102 can select another transportation request (e.g., the second transportation request 418). Changes in the current and historical data associated with a given region and/or sub-region can thus change which transportation request the network coverage efficiency system 102 selects for a provider device.

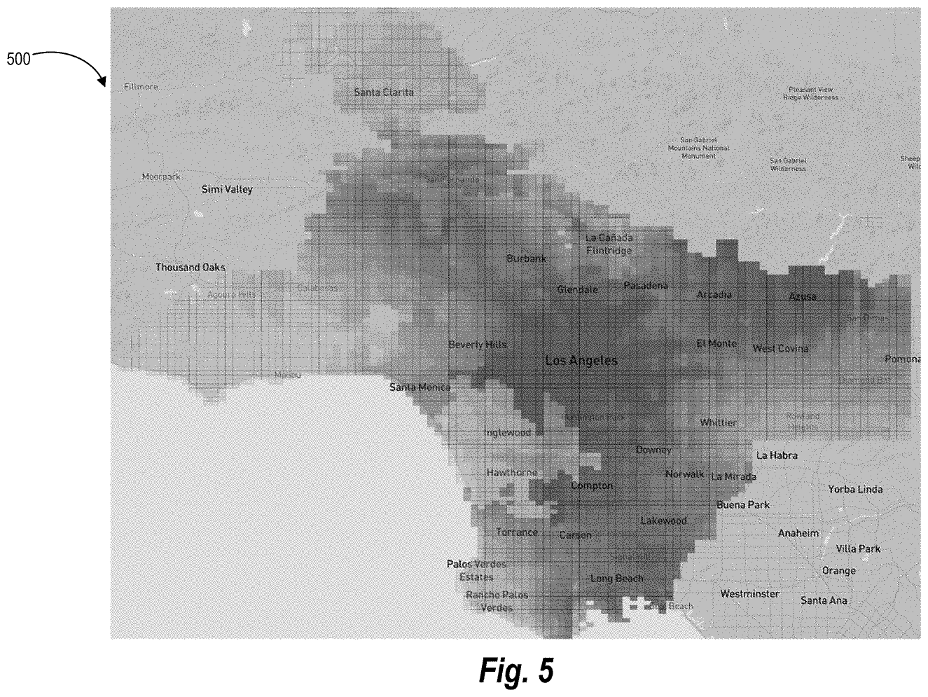

FIG. 5 illustrates a map diagram 500 of network coverage of a transportation matching system for a geographical area and for a particular time period. In particular, FIG. 5 illustrates a plurality of different regions and sub-regions in the geographical area. More specifically, the map diagram 500 includes different shaded portions representing the average response time and transportation time (e.g., the P2 and P3 times) associated with transportation requests in the different regions and sub-regions. The darker areas represent shorter total times for transportation requests and the lighter areas represent longer total times for transportation requests.

Accordingly, as illustrated, different regions can have different wait times and travel times for requesters based on the characteristics of the requests and availability of provider devices in the regions. The network coverage efficiency system 102 can improve the total times for transportation requests in different regions and sub-regions by more efficiently managing network coverage of provider devices, especially when the availability of provider devices is insufficient to meet the number of transportation requests in a given region. Specifically, the network coverage efficiency system 102 can generate network coverage improvement metrics that reflect the driver opportunity cost of assigning the driver to any particular transportation request. By considering the driver opportunity cost of various drivers and transportation requests (and the transportation value of the transportation requests), the network coverage efficiency system 102 can determine how to match the transportation requests according to characteristics of provider devices in the regions, historical data for the regions, and other data associated with the transportation requests.

Although FIGS. 3-4B describe particular approaches for determining a network coverage improvement metric, the network coverage efficiency system 102 can utilize alternate approaches. For example, the network coverage efficiency system 102 can consider additional signals or features and utilize a variety of models in determining the network coverage improvement metric. Indeed, the network coverage efficiency system 102 can consider a variety of features, such as the destination location, the estimated down time at the destination location, average ETA at the destination location, a length of a ride, conversion probability, cancellation probability (e.g., post-dispatch cancellation probability), or other features that effect driver opportunity cost in determining the network coverage improvement metric. Thus, if a transportation request will remove a provider device from servicing transportation requests for a significant period of time (as a result of a destination having few transportation requests, a high cancellation probability, or a long travel time), the network coverage efficiency system 102 can account for these factors in determining the network coverage improvement metric. Accordingly, the network coverage efficiency system 102 can penalize longer rides or longer down-time and emphasize more efficient transportation requests with shorter durations that will improve network coverage and the amount of throughput in the system. Moreover, the network coverage efficiency system 102 can utilize a variety of machine learning models, optimization algorithms, or heuristic approaches to determine the network coverage improvement metric (e.g., a driver opportunity cost).

Moreover, in some instances the network coverage improvement metric does not influence selection of a transportation match. For example, the network coverage improvement metric can indicate that a device imbalance does not exist (e.g., that there are more driver devices than rider devices) and therefore, there is little (or no) efficiency improvements resulting from not assigning a provider device. Indeed, if the opportunity cost of assigning a provider device to a transportation request is zero, the network coverage efficiency system 102 can default to other metrics (e.g., transportation value) for assigning a transportation request.

As mentioned, the network coverage efficiency system 102 can also generate and consider unmatched requester device efficiency metrics in matching transportation requests via a transportation matching system. FIG. 6 illustrates a diagram of an overview of a process in which the network coverage efficiency system 102 generates a transportation match for a transportation request based on an unmatched requester device efficiency metric determined utilizing a Markov decision model (e.g., a Markov stopping problem model). Specifically, FIG. 6 illustrates utilizing a Markov decision model policy to determine an unmatched requester device efficiency metric and generate a transportation match.

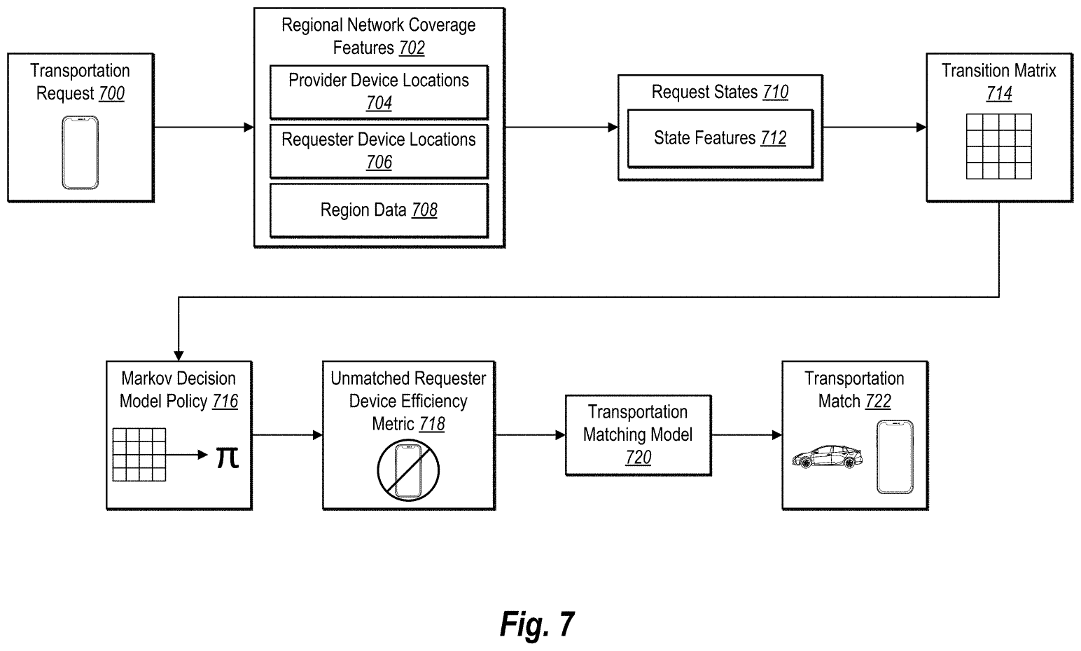

According to one or more embodiments, as illustrated in FIG. 6, the network coverage efficiency system 102 receives a transportation request 600 to provide transportation services for a requester associated with a requester device. In connection with receiving the transportation request 600, FIG. 6 illustrates that the network coverage efficiency system 102 utilizes transportation provider device data 602 to determine a Markov decision model policy 604 associated with the transportation request. For instance, as described in more detail below with respect to FIG. 7, the network coverage efficiency system 102 determines the Markov decision model policy 604 according to a plurality of possible request states with a plurality of state features corresponding to the transportation request 600. Additionally, as described in more detail with respect to FIG. 7, the network coverage efficiency system 102 utilizes the Markov decision model policy 604 to generate an unmatched requester device efficiency metric 610 associated with the transportation request 600.

Additionally, as illustrated in FIG. 6, the network coverage efficiency system 102 generates a predicted request metric 606 associated with the transportation request 600. Specifically, the predicted request metric 606 can include a transportation value (e.g., a predicted cost or a predicted transportation distance/time) based on the transportation request 600. Additionally, as described in more detail below, the network coverage efficiency system 102 can compare the predicted request metric 606 to the unmatched requester device efficiency metric 610 generated based on the Markov decision model policy 604 (or otherwise analyzes the unmatched requester device efficiency metric in connection with the predicted request metric 606) to generate a transportation match 608. For example, the network coverage efficiency system 102 can determine a difference between the predicted request metric 606 and the unmatched requester device efficiency metric 610 and determine whether to generate the transportation match 608 or leave the transportation request 600 unassigned for the current time period. In alternative embodiments, the network coverage efficiency system 102 generates the transportation match 608 utilizing the unmatched requester device efficiency metric based on the Markov decision model policy 604 and without the predicted request metric 606.

By utilizing this approach, the network coverage efficiency system 102 can model the value of leaving the current transportation match unassigned. Indeed, the network coverage efficiency system 102 can explore the likelihood and results of possible paths leading from the current state to determine this unmatched requester device efficiency metric. Thus, the unmatched requester device efficiency metric can reflect the likelihood of finding a new provider device, with a better provider device rate, a higher conversion rate, and a lower ETA based on the amount of time remaining for the transportation request. By analyzing the likelihood that the efficiency of a transportation match will improve or degrade over time, the network coverage efficiency system 102 can generate transportation matches more efficiently and accurately at any given state.

FIG. 7 illustrates a detailed diagram of a process in which the network coverage efficiency system 102 generates an unmatched requester device efficiency metric in connection with a transportation request. Specifically, FIG. 7 illustrates that the network coverage efficiency system 102 generates the unmatched requester device efficiency metric based on a Markov decision model for a plurality of possible request states associated with the transportation request and a region in which the transportation request is located. Additionally, FIG. 7 illustrates that the network coverage efficiency system 102 generates a transportation match from the unmatched requester device efficiency metric.

As illustrated in FIG. 7, in one or more embodiments, the network coverage efficiency system 102 receives a transportation request 700 from a requester device. In particular, the transportation request 700 is located within a specific region. Additionally, the transportation request 700 can be positioned within a specific sub-region (e.g., geohash) of the region. Furthermore, one or more provider devices can be located within or near the sub-region associated with the transportation request 700.

In response to receiving the transportation request 700, the network coverage efficiency system 102 determines data associated with the transportation request 700 based on the region and/or sub-region of the transportation request 700. Specifically, as illustrated in FIG. 7, the network coverage efficiency system 102 determines regional network coverage features 702 for the region in which the transportation request 700 is located. In one or more embodiments, the regional network coverage features 702 include provider device locations 704, requester device locations 706, and region data 708 (similar to the location and region data discussed above with regard to FIG. 3 or other features disclosed herein). Accordingly, the regional network coverage features 702 provide signals to the network coverage efficiency system 102 related to network coverage of provider devices relative to transportation requests for the region. In additional embodiments, the network coverage efficiency system 102 also determines sub-region network coverage features for a sub-region associated with the transportation request 700 and/or sub-regions nearby the transportation request 700.

In one or more embodiments, the provider device locations 704 of the regional network coverage features 702 include location data associated with provider devices within or near the region of the transportation request 700. Additionally, in one or more embodiments, the requester device locations 706 include location data associated with requester devices (e.g., associated with transportation requests) in or near the region. Furthermore, the region data 708 can include a region identifier and specific details associated with the region (e.g., population, demographics, traffic data, entities, tourism data, previous transportation requests). In additional embodiments in which the network coverage efficiency system 102 also utilizes sub-region network coverage features, the network coverage efficiency system 102 can similarly determine provider device locations, requester device locations, and sub-region data for the corresponding sub-region(s).

As illustrated in FIG. 7, the network coverage efficiency system 102 determines request states 710 for the transportation request 700. As used herein, the term “request state” or “possible request state” refers to a configuration of parameters associated with a transportation request. For example, a request state can include contextual information associated with a transportation request based on a region associated with the transportation request. In one or more embodiments, as illustrated in FIG. 7, the request states 710 include state features 712 that represent the different configurations of parameters associated with the transportation request. Specifically, the network coverage efficiency system 102 discretizes the request states 710 according to the state features 712.

Additionally, as used herein, the term “state feature” refers to a particular parameter associated with a transportation request. For instance, a state feature includes a characteristic associated with one or more provider devices within a region corresponding to a transportation request. In one or more embodiments, a state feature includes, but is not limited to, a number of provider devices within or near a region in which a transportation request is located, a proximity (e.g., distance and/or time) of one or more provider devices within or near the region, or a transportation value (e.g., rate) associated with one provider devices within or near the region. Additionally, a state feature can include a characteristic of a region including, but not limited to, historical data corresponding to provider devices and transportation requests within or near the region, locations of tolls, other transportation vehicles or services in the region, types of transportation vehicles associated with provider devices, transportation vehicle insurance, etc.

In some embodiments, a state feature also includes a conversion probability (e.g., a probability of a transportation request being accepted by a provider device) based on other contextual information associated with a transportation request. For example, the network coverage efficiency system 102 can utilize a prediction model (e.g., a machine-learning model) to generate a conversion probability based on current provider devices and transportation requests in or near the region and historical numbers of provider devices and transportation requests in or near the region. To illustrate, the conversion probability may be higher for a transportation request if a provider device is nearby and lower for a transportation request if a provider is not nearby. The network coverage efficiency system 102 can also determine the specific probability based on a comparison to historical data for the region. Thus, the network coverage efficiency system 102 can determine a conversion probability corresponding to a particular configuration of provider devices and transportation requests based on historical conversions associated with the particular configuration.

Because contextual information associated with transportation requests can change over time, a transportation request can transition between request states when the contextual information changes. To illustrate, if the number of provider devices, transportation requests, or other details associated with the provider devices and/or transportation requests in or near the region changes, the transportation request can transition to a new request state. For example, a first request state can correspond to a transportation request when a nearest provider device is within a first proximity, a second request state can correspond to the transportation request when a nearest provider device is within a second proximity, etc. If a provider device becomes available within the first proximity when the transportation request is in the second request state, the transportation request transitions to the first request state. Although the above example refers to request states with state features based on provider device proximity, request states can include any number of state features, resulting in complex transitions between a plurality of possible request states.

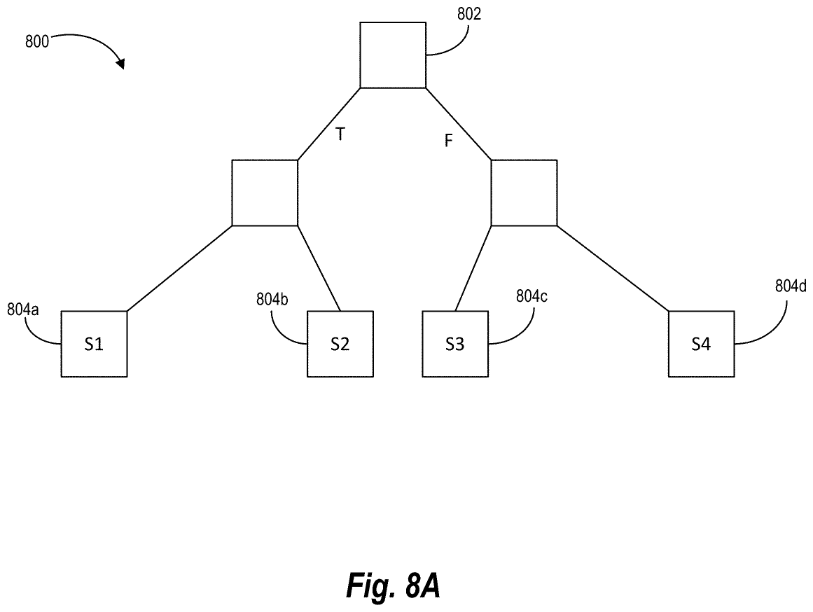

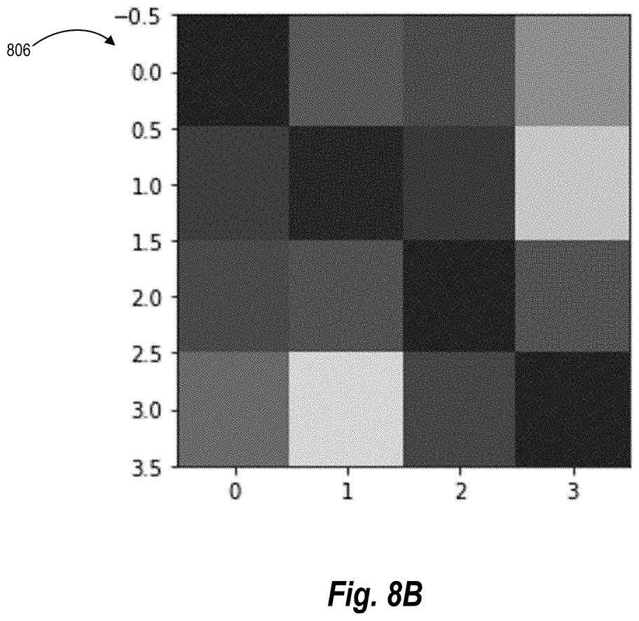

As illustrated in FIG. 7, in connection with the request states 710, the network coverage efficiency system 102 can generate a transition matrix 714 representing the probabilities of transitioning between request states. According to one or more embodiments, the network coverage efficiency system 102 utilizes a Markov decision process to model the problem of maximizing a variable (e.g., ride efficiency, value, driver cost, profit, or conversion probability) of the transportation request 700. As described in more detail with respect to FIG. 8A, for example, the network coverage efficiency system 102 utilizes the Markov decision process to learn the probability of transitioning from a request state to any other request state. The network coverage efficiency system 102 can then generate the transition matrix 714 based on the learned probabilities. In one or more embodiments, the network coverage efficiency system 102 operates under the assumption that the transition probability from any request state to any other request state is memoryless. In other words, the network coverage efficiency system 102 can operate under a conclusion that knowing the state features (e.g., counts of provider devices waiting for requests or in transit to requests) is sufficient to estimate the probability that values of these state features will increase or decrease.

After, or otherwise in connection with, determining the transition matrix 714 for the transportation request 700, the network coverage efficiency system 102 determines a Markov decision model policy 716 for the transportation request 700. Specifically, the network coverage efficiency system 102 determines the Markov decision model policy 716 associated with maximizing a parameter associated with the transportation request 700. As used herein, the term “Markov decision model policy” refers to a decision policy that indicates whether to assign a provider device to a transportation request during a particular request state for the transportation request. For instance, the network coverage efficiency system 102 can determine the Markov decision model policy 716 to maximize a score (e.g., representation of network coverage) in connection with the transportation request 700 and one or more provider devices within the region. In some embodiments, the network coverage efficiency system 102 determines the Markov decision model policy 716 to maximize a transportation value (e.g., a profit) in connection with the transportation request 700 and other transportation requests within the region.

In one or more embodiments, the network coverage efficiency system 102 determines the transition matrix 714 and the Markov decision model policy 716 as part of the Markov decision process. Specifically, the network coverage efficiency system 102 utilizes the Markov decision process to simultaneously learn the transition matrix 714 and determine the Markov decision model policy 716 to achieve a particular result or goal. Thus, the network coverage efficiency system 102 can determine the Markov decision model policy 716 that achieves the desired result for each request state given the transition probabilities indicated in the transition matrix 714. Accordingly, the Markov decision model policy 716 can reflect a solution to a Markov decision stopping problem that reflects a stopping condition (e.g., a value or efficiency) at which the network coverage efficiency system 102 will stop waiting and assign a transportation request to a provider device.

FIG. 7 also illustrates that the network coverage efficiency system 102 determines an unmatched requester device efficiency metric 718 for the transportation request 700 based on a current request state for the transportation request 700 and based on the Markov decision model policy 716. As used herein, the term “unmatched requester device efficiency metric” refers to an estimated measure of the value, efficiency, or improvement resulting from leaving a transportation request unmatched during a particular time period (e.g., an open demand value). For example, the unmatched requester device efficiency metric 718 can indicate the network coverage resulting from not matching the transportation request 700 during an immediate time window (and/or one or more subsequent cycles representing one or more future time windows). Thus, a higher unmatched requester device efficiency metric represents a different expected measure of network coverage during the next cycle than a lower unmatched requester device efficiency metric. In some embodiments, the unmatched requester device efficiency metric 718 indicates an expected transportation value (e.g., profit) associated with leaving the transportation request 700 unmatched for one or more future cycles.

After determining the unmatched requester device efficiency metric 718 for the transportation request 700, the network coverage efficiency system 102 utilizes a transportation matching model 720 to generate a transportation match 722 for the transportation request 700. For example, the network coverage efficiency system 102 determines whether to match the transportation request 700 to a provider device given the current request state and given a remaining amount of time associated with the transportation request 700. To illustrate, the network coverage efficiency system 102 utilizes the unmatched requester device efficiency metric 718 to determine when to match a provider device to the transportation request 700.

In one or more embodiments, the network coverage efficiency system 102 utilizes the transportation matching model 720 to compare the unmatched requester device efficiency metric 718 of the transportation request 700 to a predicted request metric based on a transportation distance/time (e.g., P3 time) associated with the transportation request 300. To illustrate, the network coverage efficiency system 102 can determine whether the predicted request metric is greater than the unmatched requester device efficiency metric 718 (or vice-versa). In response to the unmatched requester device efficiency metric 718 being less than the predicted request metric, the network coverage efficiency system 102 can generate the transportation match 722.

In additional embodiments, the network coverage efficiency system 102 utilizes a threshold to determine whether to generate the transportation match 722 according to the unmatched requester device efficiency metric 718. For instance, the network coverage efficiency system 102 determines the threshold based on the request states 710 and the transition matrix 714. The network coverage efficiency system 102 can then compare the unmatched requester device efficiency metric 718 to the threshold to determine whether to generate the transportation match 722. Alternatively, the network coverage efficiency system 102 determines a difference between the unmatched requester device efficiency metric 718 and the predicted request metric and then compares the difference to the threshold to determine whether to generate the transportation match 722.

In some embodiments, the network coverage efficiency system 102 generates the unmatched requester device efficiency metric 718 for a particular time cycle according to a remaining time of the transportation request 700 (e.g., based on a deadline when the request lapses). Specifically, the network coverage efficiency system 102 can first determine a predetermined amount of time (e.g., a number of seconds or minutes). Accordingly, the network coverage efficiency system 102 can separate a remaining time of the transportation request 700 into a plurality of time cycles based on the predetermined amount of time. The network coverage efficiency system 102 can then generate the unmatched requester device efficiency metric 718 for the current time cycle, which indicates the measurement resulting from leaving the transportation request 700 unmatched during the current time cycle. If the transportation request 700 remains unmatched after the time cycle, the network coverage efficiency system 102 generates a new unmatched requester device efficiency metric for the next time cycle.

In one or more embodiments, the network coverage efficiency system 102 utilizes unmatched requester device efficiency metrics for a plurality of transportation requests to generate a transportation match. In particular, if the number of provider devices is insufficient to generate transportation matches for all pending transportation requests at any given time, the network coverage efficiency system 102 can utilize the unmatched requester device efficiency metrics of the pending transportation requests to select a transportation request for a particular provider device. To illustrate, the network coverage efficiency system 102 can generate separate unmatched requester device efficiency metrics for the transportation requests according to the corresponding request states, transition matrices, and Markov decision model policies of the transportation requests.

According to various embodiments, the request states, transition matrices, and Markov decision model policies can be different for each transportation request according to the context information associated with the transportation request. As an example, the network coverage efficiency system 102 determines a first transition matrix for a first transportation request in a first sub-region and a second transition matrix for a second transportation request in a second sub-region. The corresponding Markov decision model policies can be different for each of the requests based on the differences in the sub-regions. To illustrate, the first transportation request may be less likely to have a nearby provider device if left unmatched than the second transportation request based on the corresponding sub-regions. The resulting unmatched requester device efficiency metrics can thus reflect these differences in context information for the transportation requests.

The network coverage efficiency system 102 can also generate a transportation match by taking the conversion probability into consideration. Consider a driver device 15 minutes away from a requester device where the network coverage efficiency system 102 forecasts a 50% chance that there will be a driver device 5 minutes away in 1 minute. Moreover, consider that the forecasted conversion probabilities and cancellation probabilities are as follows:
P(conv.|ETA=15 min)=90%
P(conv.|ETA=5 min)=98%
P(pre-dispatch cancel |pre-dispatch wait of 1 min)=3%.

A conventional approach may match the provider device that is 15 minutes away, thereby resulting in an inefficient network coverage. The network coverage efficiency system 102 can utilize the conversion probability to determine whether to match to the currently available provider device as:

(1−P(pre−matching cancel|pre−matching wait time 1 min))·1/2·(P(conv.|ETA=15 min)+P(conv.|ETA=5 min))

The resulting unmatched requester device efficiency metric can thus be 97% * 94%=91%. The network coverage efficiency system 102 can then determine to leave the transportation request unmatched due to the higher conversion probability than by matching the request to the currently available provider device that is 15 minutes away.

In additional embodiments, the network coverage efficiency system 102 leverages the unmatched requester device efficiency metric to optimize for transportation values associated with different provider devices. For instance, different provider devices may have different corresponding transportation values due to characteristics of the corresponding providers, transportation vehicles, etc. According to one example, matching a first provider device to a transportation request generates a first predicted transportation metric (e.g., $2.00) based on a first transportation value (e.g., $4). The network coverage efficiency system 102 also determines that there is a 50% chance of finding a second provider device in 1 minute with the same ETA with a 3% chance of pre-matching cancellation while waiting for the second provider device. Matching the second provider device to the transportation request would generate a second predicted transportation metric (e.g., $2.40) based on a second transportation value (e.g., $3.60).

A conventional approach may match the first provider device to the transportation request at the time of the request and realize the first predicted transportation metric. The network coverage efficiency system 102, however, can generate the unmatched requester device efficiency metric to account for the different transportation values and predicted transportation metrics. To illustrate, the network coverage efficiency system 102 determines the unmatched requester device efficiency metric corresponding to not matching the transportation request as 97% * $2.2=$2.13. Accordingly, the network coverage efficiency system 102 does not match the request to the first provider device based on the unmatched requester device efficiency metric being higher than the first predicted transportation metric associated with the first provider device.

According to one or more embodiments, the network coverage efficiency system 102 generates unmatched requester device efficiency metrics for transportation requests to improve network coverage for a region. For example, the network coverage efficiency system 102 utilizes the unmatched requester device efficiency metrics to determine more accurate costs, profits, or other scores indicating network coverage efficiency associated with matching transportation requests to provider devices. Specifically, the network coverage efficiency system 102 generates a score s for a dispatch decision d for a particular provider device as:

s(d)=E[Transportation Value|d]−|E[Transportation Value|w]

in which w represents the dispatch decision associated with leaving the request open until the next cycle. Thus, s(d) represents the incremental improvement in network coverage efficiency due to a predicted request metric for the dispatch decision d relative to the unmatched requester device efficiency metric for the dispatch decision w of the request.

In one or more embodiments, the network coverage efficiency system 102 generates a score for a transportation request based on a Markov decision model policy according to the following algorithm:

J_{π}(t)=E[s|s≥π(t)]+P(s<π(t))·J_π(t−Δt)

in which π represents a Markov decision model policy, and π(t) represents a threshold in which t is a remaining time available until a transportation request lapses. Specifically, J_{π}(t) refers to the expected score obtained by running the policy π for a transportation request lapsing in t units of time. Furthermore, Δt represents the cycle length, s is a random variable corresponding to a highest score for the current cycle. In one or more embodiments, the network coverage efficiency system 102 determines the unmatched requester device efficiency metric as arg max/πJ_{π}, which represents a threshold to maximize the expected score.

7C

As mentioned, the network coverage efficiency system 102 can also determine the unmatched requester device efficiency metric based on the time remaining for a transportation request (e.g., the unmatched requester device efficiency metric is lapse aware). Thus, for instance, the network coverage efficiency system 102 can consider multiple time cycles between a present time and a lapse time in determining the unmatched requester device efficiency metric. In one or more embodiments, the network coverage efficiency system 102 generates the unmatched requester device efficiency metric for a particular time cycle according to a model represented below as:

ODV(t)=(1−γ)·(μ·π·r+(1−μ)·ODV(t−Δt))+γ·NES(cancel)

Specifically, μ represents the probability of finding a new provider device between two cycles, and y represents the probability that a requester device cancels a transportation request between two cycles. Additionally, NES(cancel) represents a negative experience score associated with a transportation request that is canceled or lapsed. Furthermore, r represents a transportation value (e.g., profit) of the transportation request. In one or more embodiments, the network coverage efficiency system 102 assumes that new provider devices have the same estimated time of arrival to a pick-up location of the transportation request. Additionally, in some embodiments, the network coverage efficiency system 102 can utilize an average conversion probability, while in other embodiments, the network coverage efficiency system 102 can account for different conversion probabilities.

As indicated above, the unmatched requester device efficiency metric for a transportation request during a particular cycle may be dependent on one or more future time cycles according to the remaining time for the transportation request. Furthermore, the network coverage efficiency system 102 can model the unmatched requester device efficiency metric for one or more time cycles as a Markov decision process. Specifically, as discussed above, the network coverage efficiency system 102 can determine a Markov decision model policy for determining whether to match the transportation request with a particular provider device at any given time in connection with possible request states and a transition matrix associated with the transportation request.

In one or more embodiments, the network coverage efficiency system 102 utilizes a decision tree to optimize a number of request states associated with a transportation request. For example, FIG. 8A illustrates a diagram of a decision tree 800 associated with a transportation request. As illustrated, the network coverage efficiency system 102 utilizes the decision tree 800 to estimate a probability of finding a provider device (e.g., within a given distance or time proximity) in any given request state.

For example, the network coverage efficiency system 102 utilizes historical data to compute a transition vector from any state to any other state. In one or more embodiments in which the transition probability is based on the number of P1 and P2 provider devices at a given time (e.g., the provider devices waiting for requests or in transit to request locations), the network coverage efficiency system can estimate the probability that these counts will increase or decrease. Additionally, for example, the network coverage efficiency system 102 can assume that if a provider device is within matchable distance (e.g., ETA <1200 seconds), the network coverage efficiency system 102 will match the provider device to the request, thus preventing a lapse. The network coverage efficiency system 102 can then use the following algorithm (i.e., Bellman Equation) to determine the probability of lapsing in any given state for time t as:

$$P ( Lapse \} {state}_{i} ; t ) = {\sum }_{j} P ( No provider device \vert {state}_{j} ) * P ( Lapse \vert {state}_{j} ; t - 1 ) * P ( {state}_{j} \vert {state}_{i} )$$

$$P ( Lapse \vert {state}_{i} ; 0 ) = P ( No provider device \vert {state}_{i} )$$

in which P(stateⱼ|stateᵢ) represents the transition probability from stateᵢ to stateⱼ, and the network coverage efficiency system 102 estimates P(No driver|stateᵢ) with the decision tree. The network coverage efficiency system 102 can solve the above equation by induction.

As illustrated in FIG. 8A, the network coverage efficiency system 102 fits the decision tree 800 that predicts the probability of not finding a provider device based on the count of P1 and P2 drivers for the current request state. The network coverage efficiency system 102 can then reduce the state space by utilizing the leaves of the tree as the request states. For example, the network coverage efficiency system 102 can determine, at each node of the decision tree 800 (e.g., at a first node 802), the network coverage efficiency system 102 can determine whether a count of P1 and/or P2 drivers meets some threshold. Accordingly, as illustrated, the network coverage efficiency system 102 utilizes the decision tree 800 to determine four request states 804a-804d (represented as “S1,” “S2,” “S3,” and “S4”).

FIG. 8B illustrates a transition matrix 806 corresponding to the request states 804a-804d based on the decision tree 800 in FIG. 8A. Specifically, as illustrated, the transition matrix 806 includes different colors corresponding to the different transition probabilities for the request states 804a-804d. For example, a first request state 804a can have a higher probability of transitioning to a second request state 804b than transitioning to a third request state. The transition matrix 806 can reflect these transition probabilities. Furthermore, the network coverage efficiency system 102 can utilize the transition matrix 806 to determine a Markov decision model policy according to (e.g., based on or otherwise in connection with) the transition matrix 806.

Utilizing a reduction of state space (from the decision tree 800 illustrated in FIG. 8A, the network coverage efficiency system 102 can fit a parametric function on a penalty (e.g., the optimal penalty) computed by solving the Bellman Equation. Using this simplified model, the network coverage efficiency system 102 can generate curves for lapsing probability (i.e., a probability of lapsing as a function of state and remaining time). This can be utilized for purposes of determining the probability of lapse for lapse aware implementations described above.

According to one or more embodiments, the network coverage efficiency system 102 utilizes the Bellman Equation to determine an unmatched requester device efficiency metric for a transportation request at time t (i.e., t units of time remaining before the request lapses), as in the algorithm below:

$$ODV ( i , 0 ) = LapsePenalty$$

$$V ( i , 0 ) = ( 1 - P ( NoProviderDevice \vert i ) ) \cdot ( c ( i ) \cdot PredictedRequestMetric - ( 1 - c ( i ) ) \cdot PostDispatchPenalty ) + P ( NoProviderDevice \vert i ) \cdot ODV ( i , 0 )$$

$$ODV ( i , t ) = ( 1 - y ) \cdot {\sum }_{j} P ( j \vert i ) \cdot V ( j , t - Δ t ) - γ \cdot PreDispatchPenalty$$

$$V ( i , t ) = max \{ ( 1 - P ( NoProviderDevice \vert i ) ) \cdot ( c ( i ) \cdot PredictedRequestMetric - ( 1 - c ( i ) ) \cdot PostDispatchPenalty ) ; ODV ( i , t ) \}$$

in which ODV(i,t) represents the unmatched requester device efficiency metric of a request left unmatched in a cycle and V(i, t) represents the predicted request metric of a request in state i. Additionally, c(i) represents the conversion probability in state i. Furthermore, γ represents the probability of pre-dispatch cancellation of the request over the time Δt. The solution of the above algorithm provides unmatched requester device efficiency metric curves (ODV as a function of state and remaining time).

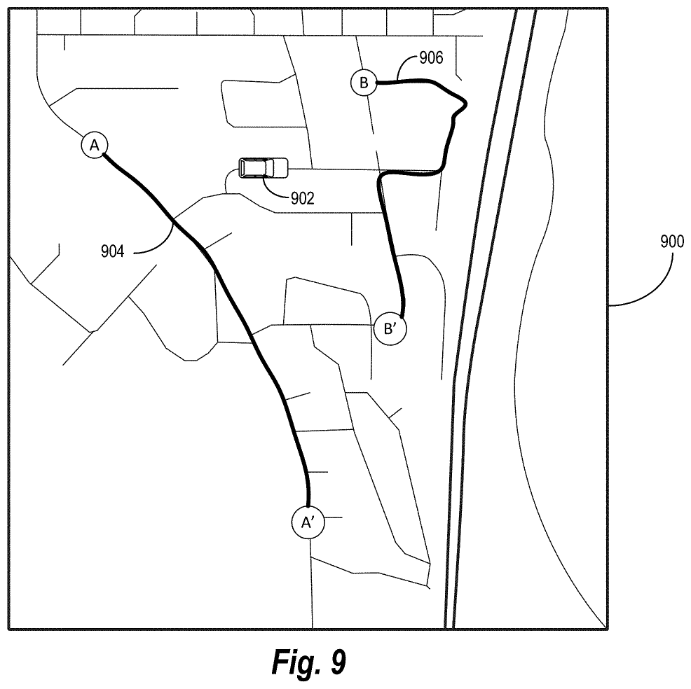

FIG. 9 illustrates a map diagram 900 of a specific example for determining whether to assign a provider device associated with a transportation vehicle 902 to one of a plurality of transportation requests. Specifically, the network coverage efficiency system 102 determines request states and transition matrices for a first transportation request 904 for a first requester and a second transportation request 906 for a second requester. The first transportation request 904 has a “time since request” value of 30 seconds, and the second transportation request 906 has a “time since request” value of 530 seconds. Furthermore, the network coverage efficiency system 102 determines that the first transportation request 904 has a transportation score of 10 (e.g., based on a distance and time associated with the request) and the second transportation request 906 has a transportation score of 6.

The network coverage efficiency system 102 determines the unmatched requester device efficiency metrics for the first transportation request 904 and the second transportation request 906 based on request-specific Markov decision model policies. In particular, the network coverage efficiency system 102 determines an unmatched requester device efficiency metric for the first transportation request 904 of 9, and an unmatched requester device efficiency metric for the second transportation request 906 of 1. The unmatched requester device efficiency metric of the first transportation request 904 is high due to the recency of the request, while the unmatched requester device efficiency metric of the second transportation request 906 is low due to nearing a lapse time of the request. The table below illustrates a comparison of matching scores for the first transportation request (“A”) and the second transportation request (“B”) based on the transportation score (“Score”) with or without the unmatched requester device efficiency metrics (“URDEM”):

| Transportation | Matching | |
|---|---|---|
| Request | w/o URDEM | Matching w/URDEM |
| A | 10 | Score(A) + URDEM(B) = 10 + 1 = 11 |
| B | 6 | Score(B) + URDEM(A) = 6 + 9 = 15 |

As shown, a conventional approach of selecting a transportation request based solely on the transportation scores results in selecting the first transportation request 904, thereby likely letting the second transportation request 906 lapse. By leveraging the unmatched requester device efficiency metrics, however, the network coverage efficiency system 102 determines that a matching score of the second transportation request 906 is higher due to the higher value associated with letting the first transportation request 904 remain unmatched during the subsequent time cycle(s). Accordingly, the network coverage efficiency system 102 can prevent lapses in a transportation matching model by leveraging the unmatched requester device efficiency metric for transportation requests.

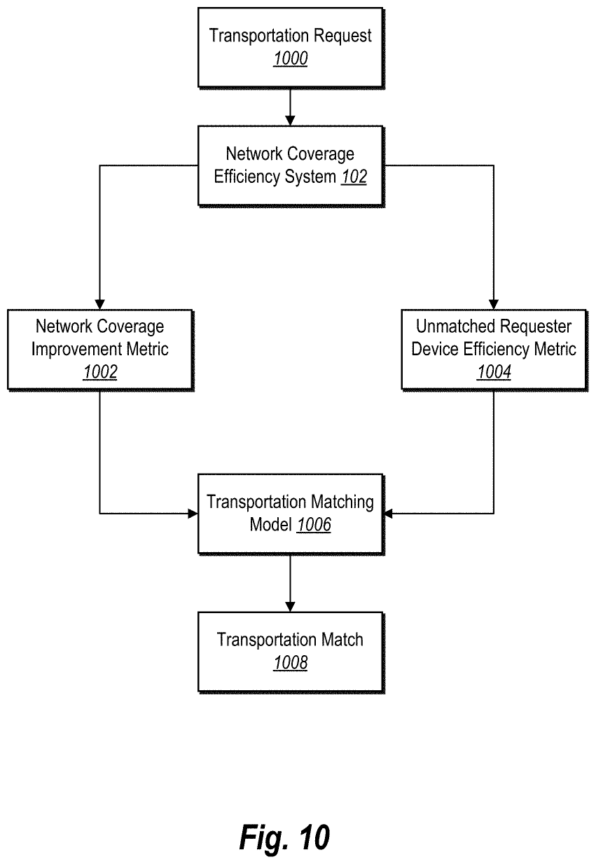

In one or more embodiments, as previously mentioned, the network coverage efficiency system 102 can determine a plurality of different metrics for generating transportation matches for transportation requests. FIG. 10 illustrates a diagram in which the network coverage efficiency system 102 generates a transportation match for a transportation request based on a network coverage improvement metric and an unmatched requester device efficiency metric. The network coverage efficiency system 102 then combines these metrics to generate a transportation match.

Specifically, FIG. 10 illustrates that the network coverage efficiency system 102 receives a transportation request 1000. The network coverage efficiency system 102 then generates a network coverage improvement metric 1002 for the transportation request 1000 relative to a provider device based on a provider device utilization score and a response time score in connection with the transportation request 1000. The network coverage efficiency system 102 also generates an unmatched requester device efficiency metric 1004 for the transportation request utilizing a Markov decision process according to possible request states for the transportation request 1000.

After generating the network coverage improvement metric 1002 and the unmatched requester device efficiency metric 1004, the network coverage efficiency system 102 can utilize a transportation matching model 1006 to generate a transportation match 1008 for the transportation request 1000. For instance, the network coverage efficiency system 102 can utilize the network coverage improvement metric 1002 to filter out one or more provider devices within or near a region of the transportation request 1002. The network coverage efficiency system 102 can then utilize the unmatched requester device efficiency metric 1004 of the transportation request 1000 to determine whether to select a specific a provider device for the transportation request 1000 or to wait until a subsequent cycle. In other embodiments, the network coverage efficiency system 102 generates weighted metrics for each of the network coverage improvement metric 1002 and the unmatched requester device efficiency metric 1004 in connection with the transportation request 1000 and then generates the transportation match 1008 based on a combined metric generated from the weighted metrics.

In some embodiments, the transportation matching model 1006 comprises an optimization model (or objective function) that combines a variety of different metrics or values to optimize for a particular variable. The transportation matching model 1006 can utilize the unmatched requester device efficiency metric 1004 and/or the network coverage improvement metric 1002 as one or more signals in this optimization model. To illustrate, the transportation matching model 1006 can optimize for an overall cost or value of a transportation match that includes costs associated with the provider device, income associated with the transportation request (e.g., payment from a rider), and time associated with servicing the transportation request. The transportation matching model 1006 can thus consider unmatched requester device efficiency metric 1004 and/or the network coverage improvement metric 1002 in determining the overall cost or value of the transportation matches and in selecting a final transportation match.

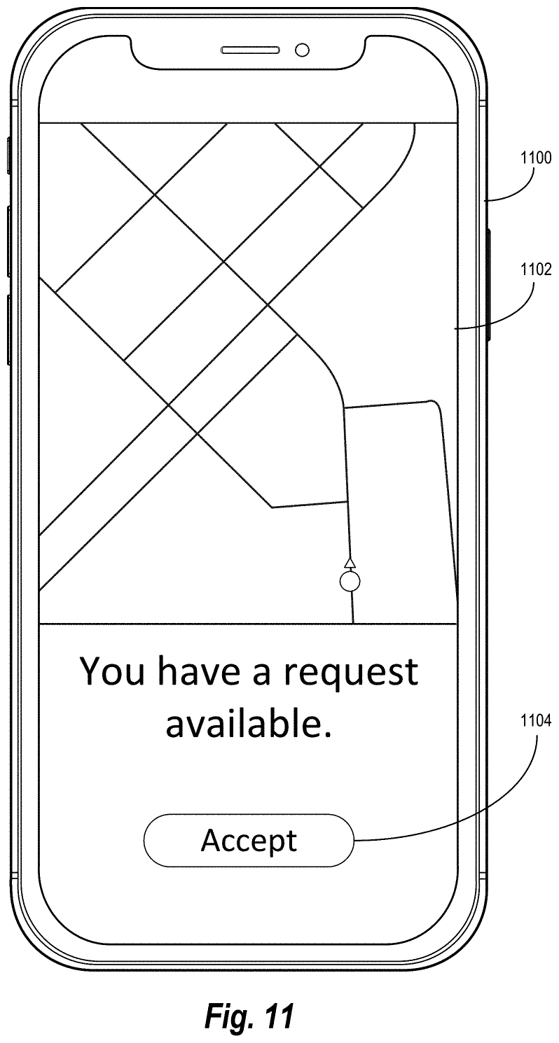

FIG. 11 illustrates a provider device 1100 including a provider application 1102 in which the network coverage efficiency system 102 (or a transportation matching system) provides an indication of a transportation request. For instance, after a requester device has submitted a transportation request, the network coverage efficiency system 102 can determine whether to match the transportation request to the provider device 1100 based on a network coverage improvement metric, an unmatched requester device efficiency metric, and/or a combination of the network coverage improvement metric and the unmatched requester device efficiency metric in connection with the transportation request and the provider device 1100. The provider device 1100 can then receive an indication of the transportation request from the network coverage efficiency system 102 and display an indication of the transportation request as a message or notification within the provider application 1102. To illustrate, the provider device 1100 includes the indication of the request in an overlay (e.g., on top of a navigation map) with a message indicating that a provider associated with the provider device 1100 has a request available. Additionally, in some embodiments, the message can include a distance (or approximate distance) of the available transportation request from the current location of the provider device 1100. Alternatively, the provider device 1100 can display available pickups in a list of pickups or another interface within the provider application 1102.

A provider associated with the provider device 1100 can then accept a transportation request after receiving an indication of the transportation request. For example, as shown in FIG. 1100, the provider device 1100 can also display an option 1104 to accept the transportation request with the message indicating the transportation request. The provider device 1100 can detect an interaction by the provider to select the option 1104 to accept the transportation request. The provider device 1100 can then send an indication of acceptance of the transportation request to the network coverage efficiency system 102. In one or more alternative embodiments, the network coverage efficiency system 102 provides a transportation request to a provider device, and the provider device automatically accepts the transportation request if the provider device is set to available.

In one or more embodiments, the network coverage efficiency system 102 utilizes the unmatched requester device efficiency metric and/or network coverage improvement metric associated with a transportation request to perform a one-sided swap of provider devices matched to the transportation request. For instance, the network coverage efficiency system 102 determines, after acceptance by a first provider device, that a second provider device is a better candidate for servicing the transportation request based on one or more of the metrics associated with the transportation request relative to each provider device. To illustrate, if the network coverage efficiency system 102 determines that the metric(s) favor the second provider device than over the first provider device, the network coverage efficiency system 102 can replace the first provider device with the second provider device (e.g., by sending a notification of the transportation request to the second provider device and cancelling the match with the first provider device).

In additional embodiments, the network coverage efficiency system 102 leverages an unmatched requester device efficiency metric and/or a network coverage improvement metric associated with a particular transportation request to provide various incentives to provider devices. In particular, the network coverage efficiency system 102 can determine that a particular region or sub-region has poor network coverage based on one or more of the metrics. The network coverage efficiency system 102 can then adjust transportation values associated with requests in the region or sub-region, generate notifications of request modifications (e.g., coupons), transportation value guarantees, or other incentives to provider devices in or near the region/sub-region to shift network coverage balance.

The network coverage efficiency system 102 can also utilize an unmatched requester device efficiency metric and/or a network coverage improvement metric to determine a value or price for a transportation request. In particular, the network coverage efficiency system 102 can utilize an unmatched requester device efficiency metric and/or a network coverage improvement metric as a feature or signal in determining prices or values to provide to requester devices for rides. For instance, the network coverage efficiency system 102 can utilize fluctuations in unmatched requester device efficiency metrics and/or network coverage improvement metric (e.g., relative to certain thresholds) to increase and decrease prices for rides. To illustrate, the network coverage efficiency system 102 can increase the price of a transportation request to increase the predicted request metrics 206, 606 and balance these predicted request metrics more evenly relative to opportunity cost and open demand value. This approach can make drive pricing more accurately reflect the impacts on system efficiency corresponding to individual transportation requests.

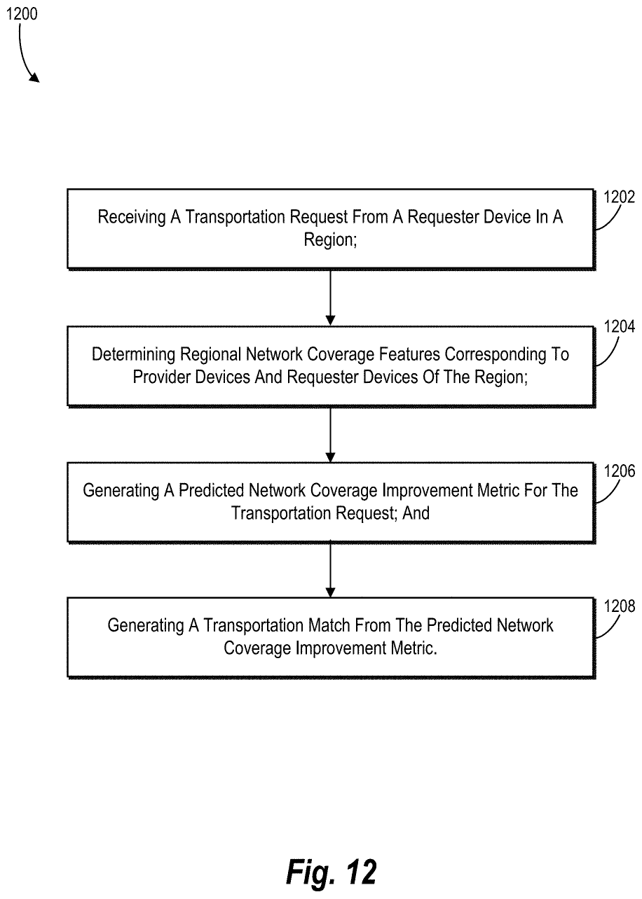

Turning now to FIG. 12, this figure illustrates a flowchart of a series of acts 1200 of utilizing a machine-learning model to generate a network coverage improvement metric for matching a transportation request to a transportation provider device. While FIG. 12 illustrates acts according to one embodiment, alternative embodiments may omit, add to, reorder, and/or modify any of the acts shown in FIG. 12. The acts of FIG. 12 can be performed as part of a method. Alternatively, a non-transitory computer readable storage medium can comprise instructions that, when executed by one or more processors, cause a computing device to perform the acts depicted in FIG. 12. In still further embodiments, a system can perform the acts of FIG. 12.

As shown in FIG. 12, the series of acts 1200 include an act 1202 of receiving a transportation request from a transportation requester device in a region. For example, act 1202 can involve receiving a transportation request to transport a request from a pick-up location in the region to a destination location.

The series of acts 1200 includes an act 1204 of determining regional network coverage features corresponding to transportation provider devices and transportation requester devices of the region. For example, act 1204 can involve receiving requester location data from a plurality of transportation requester devices associated with a plurality of transportation requests within the region. Act 1204 can also involve receiving provider location data and provider availability indications from a plurality of transportation provider devices within the region. Act 1204 can further involve determining the regional network coverage features based on the requester location data, the provider location data, and the provider availability indications. Act 1206 can involve determining a difference between a number of transportation requester devices and a number of transportation provider devices within the region.

Additionally, the series of acts 1200 includes an act 1206 of generating a predicted network coverage improvement metric for the transportation request. For example, act 1206 involves generating, utilizing a machine-learning model, a predicted network coverage improvement metric resulting from not assigning a transportation provider device to the transportation request according to the regional network coverage features.

Act 1206 can involve generating, utilizing the machine-learning model, a provider device utilization score based on a predicted measure of incremental fulfilled transportation requests per additional transportation provider device availability metric within the region. Act 1206 can then involve generating the predicted network coverage improvement metric based on the provider device utilization score.

Act 1206 can also involve determining, utilizing a device utilization model, a threshold response time associated with transportation requests in the region from network coverage for the region. Act 1206 can involve generating a response time score based on a predicted response time for the transportation request and the threshold response time. For example, act 1206 can involve generating a response time score based on a threshold response time associated with transportation requests in a geohash of the region from network coverage for the geohash. Act 1206 can then involve generating the predicted network coverage improvement metric further based on the response time score. For example, act 1206 can involve combining a weighted average of the provider device utilization score and the response time score.

Act 1206, or an additional act, can involve generating an additional response time score based on an additional threshold response time associated with transportation requests in an additional geohash of the region from network coverage for the additional geohash. Act 1206 or the additional act can then involve generating an additional predicted network coverage improvement metric resulting from not assigning an additional transportation provider device to an additional transportation request based on the provider device utilization score and the additional threshold response time.

Act 1206 can involve generating a predicted transportation time and a predicted idle time for the transportation provider device in connection with the transportation request. Act 1206 can further involve generating the predicted network coverage improvement metric further based on the predicted transportation time and the predicted idle time.

The series of acts 1200 also includes an act 1208 of generating a transportation match from the predicted network coverage improvement metric. For example, act 1208 involves generating, utilizing a transportation matching model, a transportation match for the transportation request from the predicted network coverage improvement metric.

Act 1208 can involve generating a request filter based on the threshold response time. For example, act 1208 can involve determining that a predicted response time for the transportation provider device in connection with the transportation request exceeds the threshold response time. Act 1208 can also involve excluding, utilizing the request filter in connection with the transportation request, transportation provider devices associated with response times greater than the threshold response time. For example, act 1208 can involve excluding, utilizing the transportation matching model, the transportation provider device from matching with the transportation request.

Act 1208 can also involve generating an unmatched requester device efficiency metric for the transportation request by utilizing a Markov decision policy corresponding to a plurality of possible request states. Act 1208 can then involve generating the transportation match based on the predicted network coverage improvement metric and the unmatched requester device efficiency metric.

Act 1208 can involve determining a predicted request metric based on an estimated travel distance or an estimated travel time of the transportation request. Act 1208 can then involve generating the transportation match based on a difference between the predicted request metric and the predicted network coverage improvement metric.

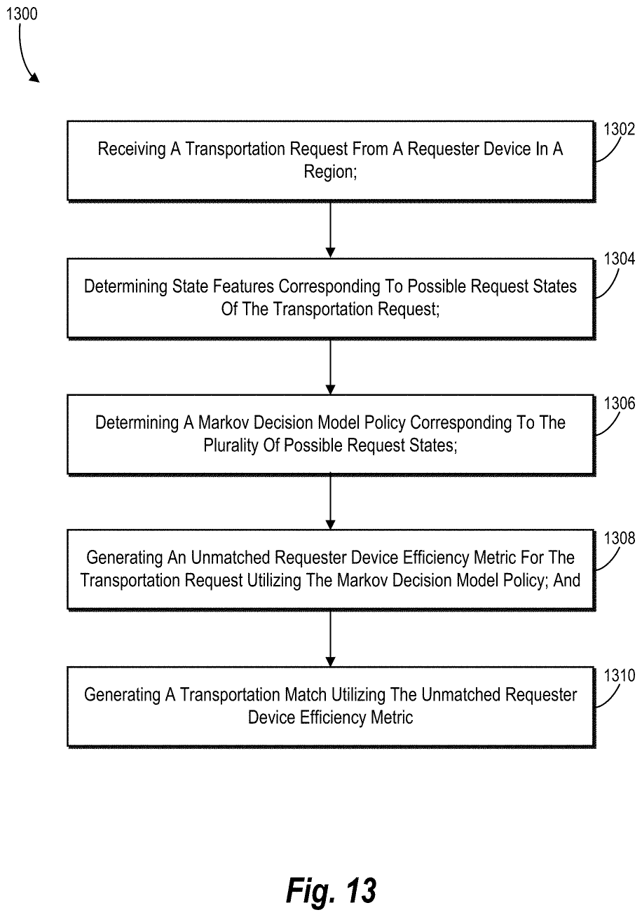

Turning now to FIG. 13, this figure illustrates a flowchart of a series of acts 1300 of utilizing a Markov decision model policy based on a plurality of request states for matching a transportation request to a transportation provider device. While FIG. 13 illustrates acts according to one embodiment, alternative embodiments may omit, add to, reorder, and/or modify any of the acts shown in FIG. 13. The acts of FIG. 13 can be performed as part of a method. Alternatively, a non-transitory computer readable storage medium can comprise instructions that, when executed by one or more processors, cause a computing device to perform the acts depicted in FIG. 13. In still further embodiments, a system can perform the acts of FIG. 13.

As shown in FIG. 13, the series of acts 1300 include an act 1302 of receiving a transportation request from a transportation requester device in a region. For example, act 1302 can involve receiving a transportation request to transport a request from a pick-up location in the region to a destination location.

The series of acts 1300 includes an act 1304 of determining state features corresponding to possible request states of the transportation request. For example, act 1304 can involve determining a plurality of state features corresponding to a plurality of possible request states of the transportation request in connection with one or more transportation provider devices. Act 1304 can involve determining provider characteristics of a plurality of transportation provider devices within the region. Act 1304 can involve determining the plurality of state features and the plurality of possible request states based on the provider characteristics.

Act 1304 can also involve determining conversion probabilities of matching the transportation request with one or more transportation provider devices according to regional characteristics of a region associated with the transportation request. Accordingly, act 1304 can involve determining the plurality of state features and the plurality of possible request states based on the conversion probabilities and the provider characteristics.

Additionally, the series of acts 1300 includes an act 1306 of determining a Markov decision model policy corresponding to the plurality of possible request states. For example, act 1306 involves determining a Markov decision model policy corresponding to the plurality of possible request states based on the plurality of state features.

Act 1306 can involve generating a transition matrix comprising probabilities of transitioning between the plurality of possible request states based on characteristics of a region or a sub-region associated with the transportation request. Act 1306 can then involve determining the Markov decision model policy based on the probabilities of transitioning between the plurality of possible request states.

The series of acts 1300 also includes an act 1308 of generating an unmatched requester device efficiency metric for the transportation request utilizing the Markov decision model policy. For example, act 1308 can involve generating an unmatched requester device efficiency metric for the transportation request utilizing the Markov decision model policy corresponding to the plurality of possible request states.

Act 1308 can involve determining a remaining time associated with the transportation request. Act 1308 can then involve generating the unmatched requester device efficiency metric for the transportation request utilizing the Markov decision model policy according to the remaining time associated with the transportation request. For example, act 1308 can involve generating a first unmatched requester device efficiency metric for the transportation request according to a first time cycle in the remaining time associated with the transportation request. Act 1308 can also involve generating a second unmatched requester device efficiency metric for the transportation request according to a second time cycle in the remaining time associated with the transportation request. In one or more embodiments, the first unmatched requester device efficiency metric is further based on the second unmatched requester device efficiency metric.

The series of acts 1300 further includes an act 1310 of generating a transportation match utilizing the unmatched requester device efficiency metric. For example, act 1310 involves generating, utilizing a transportation matching model, a transportation match for a matched transportation provider device utilizing the unmatched requester device efficiency metric.

The series of acts 1300 can include receiving an additional transportation request from an additional transportation requester device in the region. The series of acts 1300 can also include determining an additional Markov decision model policy corresponding to the additional transportation request. The series of acts 1300 can then include generating an additional unmatched requester device efficiency metric for the additional transportation request utilizing the additional Markov decision model policy. Furthermore, the series of acts 1300 can include generating the transportation match for the matched transportation provider device utilizing the unmatched requester device efficiency metric and the additional unmatched requester device efficiency metric.

Embodiments of the present disclosure may comprise or utilize a special-purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or generators and/or other electronic devices. When information is transferred, or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface generator (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural marketing features and/or methodological acts, it is to be understood that the subject matter defined in the appended claims is not necessarily limited to the described marketing features or acts described above. Rather, the described marketing features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program generators may be located in both local and remote memory storage devices.

Embodiments of the present disclosure can also be implemented in cloud computing environments. In this description, “cloud computing” is defined as a subscription model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing subscription model can be composed of various characteristics such as, for example, on-demand self-service, broad network access, resource pooling, rapid elasticity, measured service, and so forth. A cloud-computing subscription model can also expose various service subscription models, such as, for example, Software as a Service (“SaaS”), a web service, Platform as a Service (“PaaS”), and Infrastructure as a Service (“IaaS”). A cloud-computing subscription model can also be deployed using different deployment subscription models such as private cloud, community cloud, public cloud, hybrid cloud, and so forth. In this description and in the claims, a “cloud-computing environment” is an environment in which cloud computing is employed.

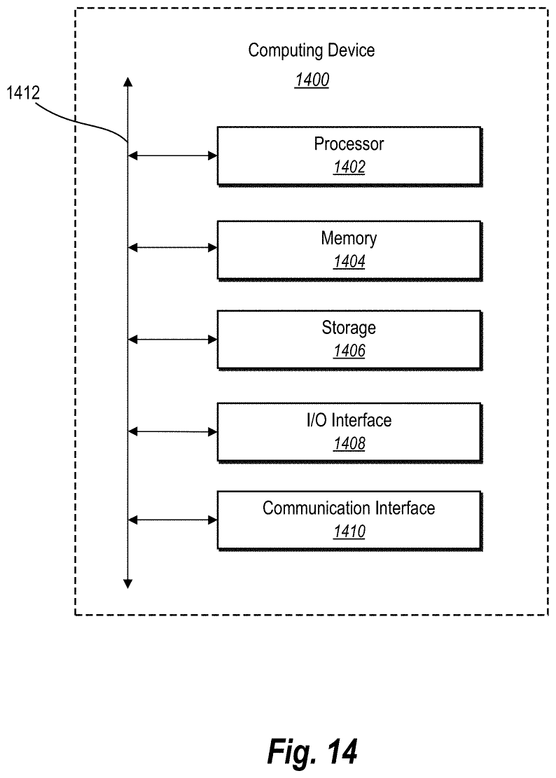

FIG. 14 illustrates a block diagram of an example computing device 1400 that may be configured to perform one or more of the processes described above. One will appreciate that one or more computing devices, such as the computing device 1400 may represent the computing devices described above (e.g., the server(s) 104, the provider devices 110a-110n, or the requester devices 116a-116n). In one or more embodiments, the computing device 1400 may be a mobile device (e.g., a mobile telephone, a smartphone, a PDA, a tablet, a laptop, a camera, a tracker, a watch, a wearable device, etc.). In some embodiments, the computing device 1400 may be a non-mobile device (e.g., a desktop computer or another type of client device). Further, the computing device 1400 may be a server device that includes cloud-based processing and storage capabilities.

As shown in FIG. 14, the computing device 1400 can include one or more processor(s) 1402, memory 1404, a storage device 1406, input/output interfaces 1408 (or “I/O interfaces 1408”), and a communication interface 1410, which may be communicatively coupled by way of a communication infrastructure (e.g., bus 1412). While the computing device 1400 is shown in FIG. 14, the components illustrated in FIG. 14 are not intended to be limiting. Additional or alternative components may be used in other embodiments. Furthermore, in certain embodiments, the computing device 1400 includes fewer components than those shown in FIG. 14. Components of the computing device 1400 shown in FIG. 14 will now be described in additional detail.

In particular embodiments, the processor(s) 1402 includes hardware for executing instructions, such as those making up a computer program. As an example, and not by way of limitation, to execute instructions, the processor(s) 1402 may retrieve (or fetch) the instructions from an internal register, an internal cache, memory 1404, or a storage device 1406 and decode and execute them.

The computing device 1400 includes the memory 1404, which is coupled to the processor(s) 1402. The memory 1404 may be used for storing data, metadata, and programs for execution by the processor(s). The memory 1404 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1404 may be internal or distributed memory.

The computing device 1400 includes the storage device 1406 for storing data or instructions. As an example, and not by way of limitation, the storage device 1406 can include a non-transitory storage medium described above. The storage device 1406 may include a hard disk drive (“HDD”), flash memory, a Universal Serial Bus (“USB”) drive or a combination these or other storage devices.

As shown, the computing device 1400 includes one or more I/O interfaces 1408, which are provided to allow a user to provide input to (such as user strokes), receive output from, and otherwise transfer data to and from the computing device 1400. These I/O interfaces 1408 may include a mouse, keypad or a keyboard, a touch screen, camera, optical scanner, network interface, modem, other known I/O devices or a combination of such I/O interfaces 1408. The touch screen may be activated with a stylus or a finger.

The I/O interfaces 1408 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1408 are configured to provide graphical data to a display for presentation to a user. The graphical data may be representative of one or more graphical user interfaces and/or any other graphical content as may serve a particular implementation.

The computing device 1400 can further include a communication interface 1410. The communication interface 1410 can include hardware, software, or both. The communication interface 1410 provides one or more interfaces for communication (such as, for example, packet-based communication) between the computing device and one or more other computing devices or one or more networks. As an example, and not by way of limitation, communication interface 1410 may include a network interface controller (“NIC”) or network adapter for communicating with an Ethernet or other wire-based network or a wireless NIC (“WNIC”) or wireless adapter for communicating with a wireless network, such as a WI-FI. The computing device 1400 can further include the bus 1412. The bus 1412 can include hardware, software, or both that connects components of computing device 1400 to each other.

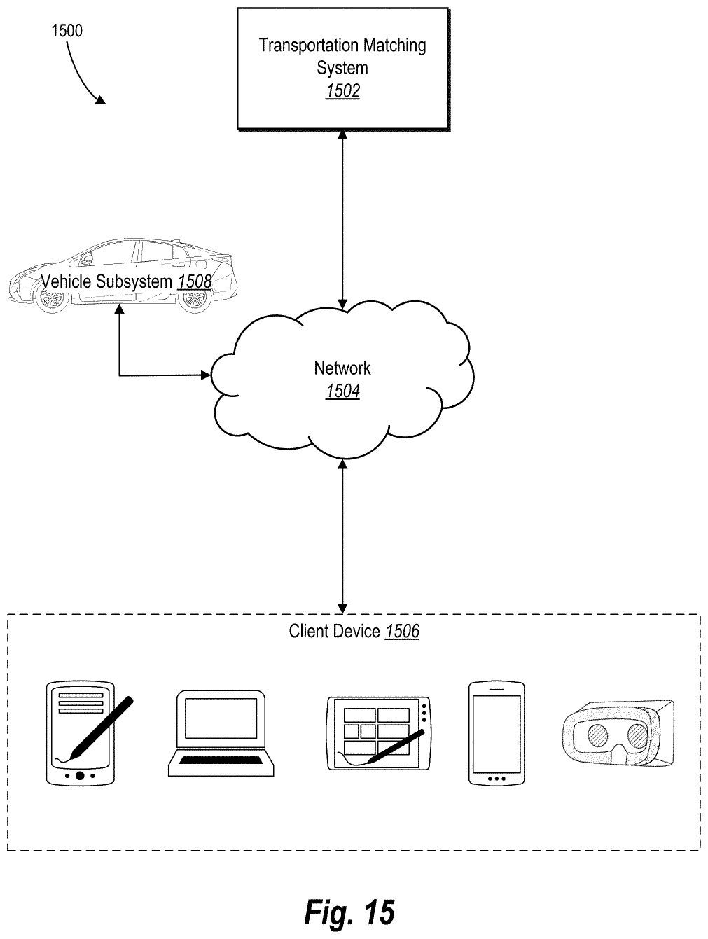

FIG. 15 illustrates an example network environment 1500 of a transportation matching system (e.g., the dynamic transportation matching system 112). The network environment 1500 includes a client device 1506, a transportation matching system 1502, and a vehicle subsystem 1508 connected to each other by a network 1504. Although FIG. 15 illustrates a particular arrangement of the client device 1506, the transportation matching system 1502, the vehicle subsystem 1508, and the network 1504, this disclosure contemplates any suitable arrangement of the client device 1506, the transportation matching system 1502, the vehicle subsystem 1508, and the network 1504. As an example, and not by way of limitation, two or more of the client device 1506, the transportation matching system 1502, and the vehicle subsystem 1508 communicate directly, bypassing the network 1504. As another example, two or more of the client device 1506, the transportation matching system 1502, and the vehicle subsystem 1508 may be physically or logically co-located with each other in whole or in part. Moreover, although FIG. 15 illustrates a particular number of the client devices 1506, the transportation matching systems 1502, the vehicle subsystems 1508, and the networks 1504, this disclosure contemplates any suitable number of the client devices 1506, the transportation matching systems 1502, the vehicle subsystems 1508, and the networks 1504. As an example, and not by way of limitation, the network environment 1500 may include multiple client devices 1506, multiple transportation matching systems 1502, multiple vehicle subsystems 1508, and multiple networks 1504.

This disclosure contemplates any suitable network 1504. As an example, and not by way of limitation, one or more portions of the network 1504 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. The network 1504 may include one or more networks 1504.

Links may connect the client device 1506, the transportation matching system 1502, and the vehicle subsystem 1508 to the network 1504 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout the network environment 1500. One or more first links may differ in one or more respects from one or more second links.

In particular embodiments, the client device 1506 may be an electronic device including hardware, software, or embedded logic components or a combination of two or more such components and capable of carrying out the appropriate functionalities implemented or supported by the client device 1506. As an example, and not by way of limitation, a client device 1506 may include any of the computing devices discussed above in relation to FIG. 15. A client device 1506 may enable a network user at the client device 1506 to access a network. A client device 1506 may enable its user to communicate with other users at other client devices 1506.

In particular embodiments, the client device 1506 may include a transportation service application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1506 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to client device 1506 one or more Hyper Text Markup Language (“HTML”) files responsive to the HTTP request. The client device 1506 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the transportation matching system 1502 may be a network-addressable computing system that can host a ride share transportation network. The transportation matching system 1502 may generate, store, receive, and send data, such as, for example, user-profile data, concept-profile data, text data, ride request data, GPS location data, provider data, requester data, vehicle data, or other suitable data related to the ride share transportation network. This may include authenticating the identity of providers and/or vehicles who are authorized to provide ride services through the transportation matching system 1502. In addition, the transportation service system may manage identities of service requesters such as users/requesters. In particular, the transportation service system may maintain requester data such as driving/riding histories, personal data, or other user data in addition to navigation and/or traffic management services or other location services (e.g., GPS services).

In particular embodiments, the transportation matching system 1502 may manage ride matching services to connect a user/requester with a vehicle and/or provider. By managing the ride matching services, the transportation matching system 1502 can manage the distribution and allocation of vehicle subsystem resources and user resources such as GPS location and availability indicators, as described herein.

The transportation matching system 1502 may be accessed by the other components of the network environment 1500 either directly or via network 1504. In particular embodiments, the transportation matching system 1502 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 1502 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable the client device 1506 or the transportation matching system 1502 to manage, retrieve, modify, add, or delete, the information stored in data storage.

In particular embodiments, the transportation matching system 1502 may provide users with the ability to take actions on various types of items or objects, supported by the transportation matching system 1502. As an example, and not by way of limitation, the items and objects may include ride share networks to which users of the transportation matching system 1502 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 1502 or by an external system of a third-party system, which is separate from the transportation matching system 1502 and coupled to the transportation matching system 1502 via the network 1504.

In particular embodiments, the transportation matching system 1502 may be capable of linking a variety of entities. As an example, and not by way of limitation, the transportation matching system 1502 may enable users to interact with each other or other entities, or to allow users to interact with these entities through an application programming interfaces (“API”) or other communication channels.

In particular embodiments, the transportation matching system 1502 may include a variety of servers, sub-systems, programs, modules, logs, and data stores. In particular embodiments, the transportation matching system 1502 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The transportation matching system 1502 may also include suitable components such as network interfaces, security mechanisms, load balancers, failover servers, management-and-network-operations consoles, other suitable components, or any suitable combination thereof. In particular embodiments, the transportation matching system 1502 may include one or more user-profile stores for storing user profiles. A user profile may include, for example, biographic information, demographic information, behavioral information, social information, or other types of descriptive information, such as work experience, educational history, hobbies or preferences, interests, affinities, or location.

The web server may include a mail server or other messaging functionality for receiving and routing messages between the transportation matching system 1502 and one or more client devices 1506. An action logger may be used to receive communications from a web server about a user's actions on or off the transportation matching system 1502. In conjunction with the action log, a third-party-content-object log may be maintained of user exposures to third-party-content objects. A notification controller may provide information regarding content objects to the client device 1506. Information may be pushed to the client device 1506 as notifications, or information may be pulled from the client device 1506 responsive to a request received from the client device 1506. Authorization servers may be used to enforce one or more privacy settings of the users of the transportation matching system 1502. A privacy setting of a user determines how particular information associated with a user can be shared. The authorization server may allow users to opt in to or opt out of having their actions logged by the transportation matching system 1502 or shared with other systems, such as, for example, by setting appropriate privacy settings. Third-party-content-object stores may be used to store content objects received from third parties. Location stores may be used for storing location information received from the client devices 1506 associated with users.

In addition, the vehicle subsystem 1508 can include a human-operated vehicle or an autonomous vehicle. A provider of a human-operated vehicle can perform maneuvers to pick up, transport, and drop off one or more requesters according to the embodiments described herein. In certain embodiments, the vehicle subsystem 1508 can include an autonomous vehicle—i.e., a vehicle that does not require a human operator. In these embodiments, the vehicle subsystem 1508 can perform maneuvers, communicate, and otherwise function without the aid of a human provider, in accordance with available technology.

In particular embodiments, the vehicle subsystem 1508 may include one or more sensors incorporated therein or associated thereto. For example, sensor(s) can be mounted on the top of the vehicle subsystem 1508 or else can be located within the interior of the vehicle subsystem 1508. In certain embodiments, the sensor(s) can be located in multiple areas at once—i.e., split up throughout the vehicle subsystem 1508 so that different components of the sensor(s) can be placed in different locations in accordance with optimal operation of the sensor(s). In these embodiments, the sensor(s) can include a LIDAR sensor and an inertial measurement unit (“IMU”) including one or more accelerometers, one or more gyroscopes, and one or more magnetometers. The sensor suite can additionally or alternatively include a wireless IMU (“WIMU”), one or more cameras, one or more microphones, or other sensors or data input devices capable of receiving and/or recording information relating to navigating a route to pick up, transport, and/or drop off a requester.

In particular embodiments, the vehicle subsystem 1508 may include a communication device capable of communicating with the client device 1506 and/or the transportation matching system 1502. For example, the vehicle subsystem 1508 can include an on-board computing device communicatively linked to the network 1504 to transmit and receive data such as GPS location information, sensor-related information, requester location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
receiving, by one or more servers, a transportation request from a transportation requester device in a region;
determining, by the one or more servers, regional network coverage features corresponding to transportation provider devices and transportation requester devices of the region;
generating, by the one or more servers utilizing a machine-learning model, a predicted network coverage improvement metric resulting from not assigning a transportation provider device to the transportation request according to the regional network coverage features; and
generating, by the one or more servers utilizing a transportation matching model, a transportation match for the transportation request from the predicted network coverage improvement metric.

2. The method as recited in claim 1, wherein determining the regional network coverage features further comprises:
receiving requester location data from a plurality of transportation requester devices associated with a plurality of transportation requests within the region;
receiving provider location data and provider availability indications from a plurality of transportation provider devices within the region; and
determining the regional network coverage features based on the requester location data, the provider location data, and the provider availability indications.

3. The method as recited in claim 1, wherein generating the predicted network coverage improvement metric further comprises:
generating, utilizing the machine-learning model, a provider device utilization score based on a predicted measure of incremental fulfilled transportation requests per additional transportation provider device availability metric within the region; and
generating the predicted network coverage improvement metric based on the provider device utilization score.

4. The method as recited in claim 3, wherein generating the predicted network coverage improvement metric further comprises:
determining, utilizing a device utilization model, a threshold response time associated with transportation requests in the region from network coverage for the region;
generating a response time score based on a predicted response time for the transportation request and the threshold response time; and
generating the predicted network coverage improvement metric further based on the response time score.

5. The method as recited in claim 4, wherein generating the predicted network coverage improvement metric further comprises combining a weighted average of the provider device utilization score and the response time score.

6. The method as recited in claim 4, wherein generating the transportation match further comprises:
generating a request filter based on the threshold response time; and
excluding, utilizing the request filter in connection with the transportation request, transportation provider devices associated with response times greater than the threshold response time.

7. The method as recited in claim 4, wherein generating the predicted network coverage improvement metric further comprises:
generating a predicted transportation time and a predicted idle time for the transportation provider device in connection with the transportation request; and
generating the predicted network coverage improvement metric further based on the predicted transportation time and the predicted idle time.

8. The method as recited in claim 1, wherein generating the transportation match further comprises:
generating an unmatched requester device efficiency metric for the transportation request by utilizing a Markov decision policy corresponding to a plurality of possible request states; and
generating the transportation match based on the predicted network coverage improvement metric and the unmatched requester device efficiency metric.

9. A system comprising:
at least one processor; and
a non-transitory computer readable storage medium comprising instructions that, when executed by the at least one processor, cause the system to:
receive a transportation request from a transportation requester device in a region;
determine regional network coverage features corresponding to transportation provider devices and transportation requester devices of the region;
generate, utilizing a machine-learning model, a predicted network coverage improvement metric resulting from not assigning a transportation provider device to the transportation request according to the regional network coverage features; and
generate, utilizing a transportation matching model, a transportation match for the transportation request from the predicted network coverage improvement metric.

10. The system as recited in claim 9, wherein the instructions that, when executed by the at least one processor, cause the system to determine the regional network coverage features further cause the system to determine a difference between a number of transportation requester devices and a number of transportation provider devices within the region.

11. The system as recited in claim 9, wherein the instructions that, when executed by the at least one processor, cause the system to generate the predicted network coverage improvement metric further cause the system to:
generate, utilizing the machine-learning model, a provider device utilization score based on a predicted measure of incremental fulfilled transportation requests per additional transportation provider device availability metric within the region;
generate a response time score based on a threshold response time associated with transportation requests in a geohash of the region from network coverage for the geohash; and
generate the predicted network coverage improvement metric based on the provider device utilization score and the response time score.

12. The system as recited in claim 11, wherein the instructions that, when executed by the at least one processor, cause the system to generate the transportation match further cause the system to:
determine that a predicted response time for the transportation provider device in connection with the transportation request exceeds the threshold response time; and
exclude, utilizing the transportation matching model, the transportation provider device from matching with the transportation request.

13. The system as recited in claim 11, wherein the instructions that, when executed by the at least one processor, cause the system to:
generate an additional response time score based on an additional threshold response time associated with transportation requests in an additional geohash of the region from network coverage for the additional geohash; and
generate an additional predicted network coverage improvement metric resulting from not assigning an additional transportation provider device to an additional transportation request based on the provider device utilization score and the additional threshold response time.

14. The system as recited in claim 9, wherein the instructions that, when executed by the at least one processor, cause the system to generate the transportation match further cause the system to:
determine a predicted request metric based on an estimated travel distance or an estimated travel time of the transportation request; and
generate the transportation match based on a difference between the predicted request metric and the predicted network coverage improvement metric.

15. A method comprising:
receiving, by one or more servers, a transportation request from a transportation requester device in a region;
determining, by the one or more servers, a plurality of state features corresponding to a plurality of possible request states of the transportation request in connection with one or more transportation provider devices;
determining, by the one or more servers, a Markov decision model policy corresponding to the plurality of possible request states based on the plurality of state features;
generating, by the one or more servers, an unmatched requester device efficiency metric for the transportation request utilizing the Markov decision model policy corresponding to the plurality of possible request states; and
generating, by the one or more servers utilizing a transportation matching model, a transportation match for a matched transportation provider device utilizing the unmatched requester device efficiency metric.

16. The method as recited in claim 15, wherein determining the plurality of state features corresponding to the plurality of possible request states further comprises:
determining provider characteristics of a plurality of transportation provider devices within the region; and
determining the plurality of state features and the plurality of possible request states based on the provider characteristics.

17. The method as recited in claim 15, wherein determining the Markov decision model policy further comprises:
generating a transition matrix comprising probabilities of transitioning between the plurality of possible request states based on characteristics of a region or a sub-region associated with the transportation request; and
determining the Markov decision model policy based on the probabilities of transitioning between the plurality of possible request states.

18. The method as recited in claim 15, wherein generating the unmatched requester device efficiency metric for the transportation request utilizing the Markov decision model policy further comprises:
determining a remaining time associated with the transportation request; and
generating the unmatched requester device efficiency metric for the transportation request utilizing the Markov decision model policy according to the remaining time associated with the transportation request.

19. The method as recited in claim 15, further comprising:
receiving an additional transportation request from an additional transportation requester device in the region;
determining an additional Markov decision model policy corresponding to the additional transportation request; and
generating an additional unmatched requester device efficiency metric for the additional transportation request utilizing the additional Markov decision model policy.

20. The method as recited in claim 19, wherein generating the transportation match further comprises generating the transportation match for the matched transportation provider device utilizing the unmatched requester device efficiency metric and the additional unmatched requester device efficiency metric.
